(19) United States
(12) Patent Application Publication
(10) Pub. No.: US 2026/0094195 A1
(43) Pub. Date: Apr. 2, 2026

(54) SYSTEM AND METHOD FOR PREDICTING GIFT PREFERENCES USING SOCIAL MEDIA DATA

(71) Applicant: Global Publishing Interactive, Inc., Troy, OH (US)

(72) Inventor: Robert Hoffer, Miami Beach, FL (US)

(21) Appl. No.: 18/903,859

(22) Filed: Oct. 1, 2024

(51) Int. Cl. G06Q 30/0601; G06Q 50/00

(52) U.S. Cl. CPC G06Q 30/0631; G06Q 10/40; G06Q 30/0641

(57) ABSTRACT

A system and method are provided for predicting gift preferences using a person's social media data. For example, natural language processing, image recognition, and machine learning models can be used by a recommender system to generate personalized gift recommendations based on a person's behaviors and interests extracted from their social media activity. The recommender system can use a machine learning (ML) model for text-and image-based analysis to distill semantic content from social media data of the gift recipient, generating a profile from the semantic content. A prediction model predicts gift preferences based on the profile, and gift recommendations are made based on the gift preferences. The recommender system includes features to adhere to the user's data-privacy selections.

### BACKGROUND

Recommender systems are tools that provide personalized suggestions to users based on their preferences, behavior, or other contextual factors. Recommender systems can be used in various domains such as content streaming to help users discover relevant media, such as music or movies, for example.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates a block diagram for a first example of a system for predicting gift recommendations using the social media of a prospective gift recipient, in accordance with certain embodiments.

FIG. 1B illustrates a block diagram for a second example of a system for predicting gift recommendations using the social media of a prospective gift recipient, in accordance with certain embodiments.

FIG. 1C illustrates a block diagram for a third example of a system for predicting gift recommendations using the social media of a prospective gift recipient, in accordance with certain embodiments.

FIG. 1D illustrates a block diagram for a fourth example of a system for predicting gift recommendations using the social media of a prospective gift recipient, in accordance with certain embodiments.

FIG. 2A illustrates an example of a first user interface of an application for predicting gift recommendations using the social media of a prospective gift recipient, in accordance with certain embodiments.

FIG. 2B illustrates an example of a second user interface of an application for predicting gift recommendations using the social media of a prospective gift recipient, in accordance with certain embodiments.

FIG. 2C illustrates an example of a third user interface of an application for predicting gift recommendations using the social media of a prospective gift recipient, in accordance with certain embodiments.

FIG. 2D illustrates an example of a fourth user interface of an application for predicting gift recommendations using the social media of a prospective gift recipient, in accordance with certain embodiments.

FIG. 3 illustrates a flow diagram for an example of a method of training, using, and updating a machine learning (ML) model, in accordance with certain embodiments.

FIG. 4 illustrates a flow diagram for an example of a method of training, using, and updating a generative adversarial network (GAN) model, in accordance with certain embodiments.

FIG. 5 illustrates a flow diagram for an example of a method for providing gift recommendations based on social media data, in accordance with certain embodiments.

FIG. 6 illustrates a routine for predicting gift preferences in accordance with one embodiment.

FIG. 7A illustrates a block diagram for an example of a transformer neural network architecture, in accordance with certain embodiments.

FIG. 7B illustrates a block diagram for an example of an encoder of the transformer neural network architecture, in accordance with certain embodiments.

FIG. 7C illustrates a block diagram for an example of a decoder of the transformer neural network architecture, in accordance with certain embodiments.

FIG. 8 illustrates an aspect of the subject matter in accordance with one embodiment.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### OVERVIEW

In some aspects, the techniques described herein relate to a method for predicting gift preferences, the method including: receiving, at one or more processors, a first identifier associated with one or more social media sites and a second identifier associated with an identity of a selected person about whom gift preferences are to be predicted; searching, by the one or more processors, the one or more social media sites based on the first identifier and the second identifier to identify social media data that is associated with the selected person, wherein the social media data is collected from the one or more social media sites and stored in a memory that is accessible to the one or more processors; processing the social media data using a recommender model to predict one or more gift recommendations for one or more gifts for the selected person; displaying, on a display, a user interface that displays the one or more gift recommendations; and monitoring interactions with the user interface to identify feedback indicating an accuracy of the recommender model in predicting the one or more gift recommendations, wherein the interactions are associated with a user who is not the selected person.

In some aspects, the techniques described herein relate to a method, further including: performing reinforcement learning using the feedback as training data to modify the recommender model.

In some aspects, the techniques described herein relate to a method, wherein monitoring the interactions with the user interface to identify the feedback includes: detecting that the interactions with the user interface indicate that a first gift recommendation of the one or more gift recommendations is a false positive, adding, to the training data, an indicator of the first gift recommendation being the false positive, detecting that the interactions with the user interface indicate that a second gift recommendation of the one or more gift recommendations is a true positive, and adding, to the training data, an indicator of the second gift recommendation being the true positive.

In some aspects, the techniques described herein relate to a method, wherein the recommender model includes a profile-generation model and a gift-prediction model, and processing the social media data using the recommender model to predict the one or more gift recommendations for the one or more gifts for the selected person includes: processing the social media data using the profile-generation model to generate a profile of the selected person, and processing the profile using the gift-prediction model to generate the one or more gift recommendations

In some aspects, the techniques described herein relate to a method, wherein processing the profile using the gift-prediction model to generate the one or more gift recommendations includes: receiving contextual information that represents a context in which a gift is to be given to the selected person, and processing the profile and the contextual information using the gift-prediction model to generate the one or more gift recommendations.

In some aspects, the techniques described herein relate to a method, wherein the profile-generation model includes: a text-analysis machine learning (ML) model that extracts first semantic content from text-based information in the social media data, wherein the text-analysis ML model includes at least one of a natural language processing (NLP) model, a named entity recognition model, a latent Dirichlet allocation model, a pre-trained language model, a transformer model, a Naive Bayes classifier model, a latent semantic analysis model, a singular value decomposition model, or a statistical model, an image-analysis ML model that extracts second semantic content from image-based information in the social media data, wherein the image-analysis model includes at least one of a semantic segmentation model, convolutional neural network model, an object detection model, a region-based model, a single shot detector model, a detection transformer model, or a vision transformer model, and wherein the profile-generation model generates the profile of the selected person based on the first semantic content and the second semantic content.

In some aspects, the techniques described herein relate to a method, wherein the gift-prediction model includes a prediction machine learning (ML) model that predicts gift preferences using the profile, wherein the prediction ML model includes a random forest model, a support vector machine model, a deep learning model, a recursive neural network model, a transformer model, a K-nearest neighbor-based collaborative filter model, a clustering model, or a classifier model.

In some aspects, the techniques described herein relate to a method, wherein the recommender model includes a profile-generation model, a prediction model, and a prediction-narrowing model, wherein processing the social media data using the recommender model to predict the one or more gift recommendations for the one or more gifts for the selected person includes: processing the social media data using the profile-generation model to generate a profile of the selected person, processing the profile using the prediction model to generate a gift preference of the selected person, and processing the gift preference and shopping information associated with the selected person using the prediction-narrowing model to generate the one or more gift recommendations for the selected person, wherein the shopping information includes at least one of a purchase history, a wish list, or one or more product reviews.

In some aspects, the techniques described herein relate to a method, wherein receiving the second identifier associated with the identity of the selected person includes at least one of: receiving, via the user interface, a user input indicating the identity of the selected person, or receiving, from an application, event data indicative of an event associated with the selected person, wherein the identity of the selected person is ascertainable from the event data.

In some aspects, the techniques described herein relate to a method, further including: receiving, via the user interface, a selection of a data privacy option of a plurality of data privacy options; and excluding a subset of the social media data based on the data privacy option before processing the social media data using the recommender model to predict the one or more gift recommendations for one or more gifts for the selected person.

In some aspects, the techniques described herein relate to a system including: one or more processors including a recommender model; a display configured to display a user interface; and a memory storing instructions that, when executed by the one or more processors, configure the system to: receive a first identifier associated with one or more social media sites and a second identifier associated with an identity of a selected person about whom gift preferences are to be predicted; search the one or more social media sites based on the first identifier and the second identifier to identify social media data that is associated with the selected person, wherein the social media data is collected from the one or more social media sites and stored in the memory; process the social media data to the recommender model to predict one or more gift recommendations based, at least in part, on the social media data; display, on the display, the user interface that displays the one or more gift recommendations; and monitor interactions with the user interface to identify feedback indicating an accuracy of the recommender model in predicting the one or more gift recommendations, wherein the interactions are associated with a user who is not the selected person.

In some aspects, the techniques described herein relate to a system, wherein the instructions further configure the system to: perform reinforcement learning using the feedback as training data to modify the recommender model to improve the accuracy.

In some aspects, the techniques described herein relate to a system, wherein the instructions further configure the system to monitor the interactions with the user interface to identify the feedback by configuring the system to: detect that the interactions with the user interface indicate that a first gift recommendation of the one or more gift recommendations is a false positive, add, to reinforcement training data, an indicator of the first gift recommendation being the false positive, detect that the interactions with the user interface indicate that a second gift recommendation of the one or more gift recommendations is a true positive, add, to the reinforcement training data, an indicator of the second gift recommendation being the true positive, and perform reinforcement learning using the reinforcement training data to modify the recommender model.

In some aspects, the techniques described herein relate to a system, wherein: the recommender model includes a profile-generation model and a gift-prediction model, and the instructions further configure the system to process the social media data using the recommender model to predict the one or more gift recommendations by configuring the system to: process the social media data using the profile-generation model to generate a profile of the selected person, and process the profile using the gift-prediction model to generate the one or more gift recommendations.

In some aspects, the techniques described herein relate to a system, wherein the instructions further configure the system to apply the profile to the gift-prediction model to generate one or more of the gift recommendations by configuring the system to: receive contextual information that represents a context in which a gift would be given to the selected person, and apply the profile together with the contextual information to the gift-prediction model to generate one or more of the gift recommendations.

In some aspects, the techniques described herein relate to a system, wherein the profile-generation model includes: a text-analysis machine learning (ML) model that extracts first semantic content from text-based information in the social media data, wherein the text-analysis ML model includes at least one of a natural language processing (NLP) model, a named entity recognition model, a latent Dirichlet allocation model, a pre-trained language model, a transformer model, a Naive Bayes classifier model, a latent semantic analysis model, a singular value decomposition model, or a statistical model, an image-analysis ML model that extracts second semantic content from image-based information in the social media data, wherein the image-analysis model includes at least one of a semantic segmentation model, a convolutional neural network model, an object detection model, a region-based model, a single shot detector model, a detection transformer model, or a vision transformer model, and wherein the profile-generation model generates the profile of the selected person based on the first semantic content and the second semantic content.

In some aspects, the techniques described herein relate to a system, wherein the gift-prediction model includes a prediction machine learning (ML) model that predicts gift preferences using the profile, wherein the prediction ML model includes a random forest model, a support vector machine model, a deep learning model, a recursive neural network model, a transformer model, a K-nearest neighbor-based collaborative filter model, a clustering model, or a classifier model.

In some aspects, the techniques described herein relate to a system, wherein: the recommender model includes a profile-generation model, a prediction model, and a prediction-narrowing model, and the instructions further configure the system to process the social media data using the recommender model to predict the one or more gift recommendations by configuring the system to: process the social media data using the profile-generation model to generate a profile of the selected person, process the profile using the prediction model to generate a gift preference of the selected person, and process the gift preference and shopping information associated with the selected person using the prediction-narrowing model to generate the one or more gift recommendations for the selected person, wherein the shopping information includes at least one of a purchase history, a wish list, or one or more product reviews.

In some aspects, the techniques described herein relate to a system, wherein the instructions further configure the system to receive the second identifier associated with the identity of the selected person by configuring the system to: receive, via the user interface, a user input indicating the identity of the selected person, or receive, from an application, event data indicative of an event associated with the selected person, wherein the identity of the selected person is ascertainable from the event data.

In some aspects, the techniques described herein relate to a non-transitory computer-readable storage medium, the computer-readable storage medium including instructions that when executed by a computer, cause the computer to: receive a first identifier associated with one or more social media sites and a second identifier associated with an identity of a selected person about whom gift preferences are to be predicted; search the one or more social media sites based on the first identifier and the second identifier to identify social media data that is associated with the selected person, wherein the social media data is collected from the one or more social media sites and stored in a memory that is accessible to the computer; process the social media data using a recommender model to predict one or more gift recommendations based, at least in part, on the social media data; display, on the display, the user interface that displays the one or more gift recommendations; and monitor interactions with a user interface to identify feedback indicating an accuracy of the recommender model in predicting the one or more gift recommendations, wherein the interactions are associated with a user who is not the selected person. In some aspects, the techniques described herein relate to a method for predicting gift preferences, the method including: receiving, at one or more processors, a first identifier associated with one or more social media sites and a second identifier associated with an identity of a selected person about whom gift preferences are to be predicted; searching, by the one or more processors, the one or more social media sites based on the first identifier and the second identifier to identify social media data that is associated with the selected person, wherein the social media data is collected from the one or more social media sites and stored in a memory that is accessible to the one or more processors; processing the social media data using a recommender model to predict one or more gift recommendations for one or more gifts for the selected person; displaying, on a display, a user interface that displays the one or more gift recommendations; and monitoring interactions with the user interface to identify feedback indicating an accuracy of the recommender model in predicting the one or more gift recommendations, wherein the interactions are associated with a user who is not the selected person.

In some aspects, the techniques described herein relate to a method, further including: performing reinforcement learning using the feedback as training data to modify the recommender model.

In some aspects, the techniques described herein relate to a method, wherein monitoring the interactions with the user interface to identify the feedback includes: detecting that the interactions with the user interface indicate that a first gift recommendation of the one or more gift recommendations is a false positive, adding, to the training data, an indicator of the first gift recommendation being the false positive, detecting that the interactions with the user interface indicate that a second gift recommendation of the one or more gift recommendations is a true positive, and adding, to the training data, an indicator of the second gift recommendation being the true positive.

In some aspects, the techniques described herein relate to a method, wherein the recommender model includes a profile-generation model and a gift-prediction model, and processing the social media data using the recommender model to predict the one or more gift recommendations for the one or more gifts for the selected person includes: processing the social media data using the profile-generation model to generate a profile of the selected person, and processing the profile using the gift-prediction model to generate the one or more gift recommendations

In some aspects, the techniques described herein relate to a method, wherein processing the profile using the gift-prediction model to generate the one or more gift recommendations includes: receiving contextual information that represents a context in which a gift is to be given to the selected person, and processing the profile and the contextual information using the gift-prediction model to generate the one or more gift recommendations.

In some aspects, the techniques described herein relate to a method, wherein the profile-generation model includes: a text-analysis machine learning (ML) model that extracts first semantic content from text-based information in the social media data, wherein the text-analysis ML model includes at least one of a natural language processing (NLP) model, a named entity recognition model, a latent Dirichlet allocation model, a pre-trained language model, a transformer model, a Naive Bayes classifier model, a latent semantic analysis model, a singular value decomposition model, or a statistical model, an image-analysis ML model that extracts second semantic content from image-based information in the social media data, wherein the image-analysis model includes at least one of a semantic segmentation model, convolutional neural network model, an object detection model, a region-based model, a single shot detector model, a detection transformer model, or a vision transformer model, and wherein the profile-generation model generates the profile of the selected person based on the first semantic content and the second semantic content.

In some aspects, the techniques described herein relate to a method, wherein the gift-prediction model includes a prediction machine learning (ML) model that predicts gift preferences using the profile, wherein the prediction ML model includes a random forest model, a support vector machine model, a deep learning model, a recursive neural network model, a transformer model, a K-nearest neighbor-based collaborative filter model, a clustering model, or a classifier model.

In some aspects, the techniques described herein relate to a method, wherein the recommender model includes a profile-generation model, a prediction model, and a prediction-narrowing model, wherein processing the social media data using the recommender model to predict the one or more gift recommendations for the one or more gifts for the selected person includes: processing the social media data using the profile-generation model to generate a profile of the selected person, processing the profile using the prediction model to generate a gift preference of the selected person, and processing the gift preference and shopping information associated with the selected person using the prediction-narrowing model to generate the one or more gift recommendations for the selected person, wherein the shopping information includes at least one of a purchase history, a wish list, or one or more product reviews.

In some aspects, the techniques described herein relate to a method, wherein receiving the second identifier associated with the identity of the selected person includes at least one of: receiving, via the user interface, a user input indicating the identity of the selected person, or receiving, from an application, event data indicative of an event associated with the selected person, wherein the identity of the selected person is ascertainable from the event data.

In some aspects, the techniques described herein relate to a method, further including: receiving, via the user interface, a selection of a data privacy option of a plurality of data privacy options; and excluding a subset of the social media data based on the data privacy option before processing the social media data using the recommender model to predict the one or more gift recommendations for one or more gifts for the selected person.

In some aspects, the techniques described herein relate to a system including: one or more processors including a recommender model; a display configured to display a user interface; and a memory storing instructions that, when executed by the one or more processors, configure the system to: receive a first identifier associated with one or more social media sites and a second identifier associated with an identity of a selected person about whom gift preferences are to be predicted; search the one or more social media sites based on the first identifier and the second identifier to identify social media data that is associated with the selected person, wherein the social media data is collected from the one or more social media sites and stored in the memory; process the social media data to the recommender model to predict one or more gift recommendations based, at least in part, on the social media data; display, on the display, the user interface that displays the one or more gift recommendations; and monitor interactions with the user interface to identify feedback indicating an accuracy of the recommender model in predicting the one or more gift recommendations, wherein the interactions are associated with a user who is not the selected person.

In some aspects, the techniques described herein relate to a system, wherein the instructions further configure the system to: perform reinforcement learning using the feedback as training data to modify the recommender model to improve the accuracy.

In some aspects, the techniques described herein relate to a system, wherein the instructions further configure the system to monitor the interactions with the user interface to identify the feedback by configuring the system to: detect that the interactions with the user interface indicate that a first gift recommendation of the one or more gift recommendations is a false positive, add, to reinforcement training data, an indicator of the first gift recommendation being the false positive, detect that the interactions with the user interface indicate that a second gift recommendation of the one or more gift recommendations is a true positive, add, to the reinforcement training data, an indicator of the second gift recommendation being the true positive, and perform reinforcement learning using the reinforcement training data to modify the recommender model.

In some aspects, the techniques described herein relate to a system, wherein: the recommender model includes a profile-generation model and a gift-prediction model, and the instructions further configure the system to process the social media data using the recommender model to predict the one or more gift recommendations by configuring the system to: process the social media data using the profile-generation model to generate a profile of the selected person, and process the profile using the gift-prediction model to generate the one or more gift recommendations.

In some aspects, the techniques described herein relate to a system, wherein the instructions further configure the system to apply the profile to the gift-prediction model to generate one or more of the gift recommendations by configuring the system to: receive contextual information that represents a context in which a gift would be given to the selected person, and apply the profile together with the contextual information to the gift-prediction model to generate one or more of the gift recommendations.

In some aspects, the techniques described herein relate to a system, wherein the profile-generation model includes: a text-analysis machine learning (ML) model that extracts first semantic content from text-based information in the social media data, wherein the text-analysis ML model includes at least one of a natural language processing (NLP) model, a named entity recognition model, a latent Dirichlet allocation model, a pre-trained language model, a transformer model, a Naive Bayes classifier model, a latent semantic analysis model, a singular value decomposition model, or a statistical model, an image-analysis ML model that extracts second semantic content from image-based information in the social media data, wherein the image-analysis model includes at least one of a semantic segmentation model, a convolutional neural network model, an object detection model, a region-based model, a single shot detector model, a detection transformer model, or a vision transformer model, and wherein the profile-generation model generates the profile of the selected person based on the first semantic content and the second semantic content.

In some aspects, the techniques described herein relate to a system, wherein the gift-prediction model includes a prediction machine learning (ML) model that predicts gift preferences using the profile, wherein the prediction ML model includes a random forest model, a support vector machine model, a deep learning model, a recursive neural network model, a transformer model, a K-nearest neighbor-based collaborative filter model, a clustering model, or a classifier model.

In some aspects, the techniques described herein relate to a system, wherein: the recommender model includes a profile-generation model, a prediction model, and a prediction-narrowing model, and the instructions further configure the system to process the social media data using the recommender model to predict the one or more gift recommendations by configuring the system to: process the social media data using the profile-generation model to generate a profile of the selected person, process the profile using the prediction model to generate a gift preference of the selected person, and process the gift preference and shopping information associated with the selected person using the prediction-narrowing model to generate the one or more gift recommendations for the selected person, wherein the shopping information includes at least one of a purchase history, a wish list, or one or more product reviews.

In some aspects, the techniques described herein relate to a system, wherein the instructions further configure the system to receive the second identifier associated with the identity of the selected person by configuring the system to: receive, via the user interface, a user input indicating the identity of the selected person, or receive, from an application, event data indicative of an event associated with the selected person, wherein the identity of the selected person is ascertainable from the event data.

In some aspects, the techniques described herein relate to a non-transitory computer-readable storage medium, the computer-readable storage medium including instructions that when executed by a computer, cause the computer to: receive a first identifier associated with one or more social media sites and a second identifier associated with an identity of a selected person about whom gift preferences are to be predicted; search the one or more social media sites based on the first identifier and the second identifier to identify social media data that is associated with the selected person, wherein the social media data is collected from the one or more social media sites and stored in a memory that is accessible to the computer; process the social media data using a recommender model to predict one or more gift recommendations based, at least in part, on the social media data; display, on the display, the user interface that displays the one or more gift recommendations; and monitor interactions with a user interface to identify feedback indicating an accuracy of the recommender model in predicting the one or more gift recommendations, wherein the interactions are associated with a user who is not the selected person.

### EXAMPLE EMBODIMENTS

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

A recommender system is a subclass of information filtering system that provides suggestions for items that are most pertinent to a particular user. Recommender systems are particularly useful when an individual needs to choose an item from a potentially overwhelming number of items that a service may offer.

Recommender systems often use either or both collaborative filtering and content-based filtering but can also use other systems such as knowledge-based systems. Collaborative filtering approaches build a model from a user's past behavior (e.g., items/media that the user previously purchased or selected and/or numerical ratings given to those items/media) as well as similar decisions made by other users. This model is then used to predict media (or ratings for media) that the user may have an interest in. Content-based filtering approaches utilize a series of discrete, pre-tagged characteristics of an item/media to recommend additional items/media with similar properties.

A recommender system can provide suggestions for decision-making processes, such as what product to purchase, what music to listen to, or what online news to read. Recommender systems are used in a variety of areas, with commonly recognized examples taking the form of playlist generators for video and music services, product recommenders for online stores, or content recommenders for social media platforms and open web content recommenders. These systems can operate using a single type of input, like music, or multiple inputs within and across platforms like news, books and search queries.

Recommender systems are limited to predicting recommendation for the user—not for third parties. For example, recommender systems require interaction with the user by either monitoring the user's consumption patterns (e.g., which movies does the user watch on a streaming service) or directly asking questions about the user's preferences.

Because the recommendations are targeted to the user recommender systems do not provide guidance to the user about products/service that someone else would want. For example, a user might want such guidance when they are shopping for a gift for someone else. Accordingly, new technologies are desired to provide a user with guidance about what type of gifts someone else is likely to want.

The disclosed technology addresses the need in the art for accurate recommendations about gift interests and preferences of colleagues, gift recipients, and family.

Existing technologies are directed at predicting the interests and preferences of the user—not the interests and preferences their associates. For example, recommender systems require interaction with the user by either monitoring the user's consumption patterns (e.g., which movies the user watches on a streaming service) or directly asking questions about the user's preferences. Similarly, targeted advertising, microtargeting, and contextual targeting can also depend on monitoring the user's interactions (e.g., using the browsing history or currently viewed web page to predict the user's interests).

Thus, each of these technologies can only predict the preferences and interests of the user himself—not the interests and preferences of a prospective gift recipient. Accordingly, a new or improved technology is desired to predict and recommend gifts that would be wanted by a particular associate of the user.

The systems and methods disclosed herein, use the social media of a prospective gift recipient to provide guidance on which possible gifts might be wanted by the recipient. Social media can be a rich source for information that is predictive of user preferences and interests. Harnessing this data to provide personalized recommendations, particularly for gifts, can significantly enhance user experience and satisfaction. The systems and methods disclosed herein leverage data from multiple social media platforms to accurately predict gift preferences. According to certain non-limiting examples, these predictions can be made using generative artificial intelligence (AI) techniques.

According to certain non-limiting examples, the systems and methods disclosed herein predict gift preferences by analyzing data from various social media feeds, including, e.g., INSTAGRAM, FACEBOOK, TWITTER, TIKTOK, and LINKED IN.

According to certain non-limiting examples, the systems and methods disclosed herein combine natural language processing (NLP), image recognition, and machine learning algorithms to generate personalized gift recommendations based on the behavior and interests of the prospective gift recipient.

The systems and methods disclosed herein can include various aspects of: (1) data collection and preparation; (2) model training; (3) prediction model architecture; (4) validation and deployment of the model; (5) managing feedback for continuous improvement; and (6) managing ethical considerations and user preferences.

Regarding data collection and preparation, the systems and methods disclosed herein can collect social media data in various forms including, e.g., posts, captions, hashtags, user interactions (e.g., likes, emotes, and comments), and shared content from multiple social media platforms. As discussed below with respect to managing ethical considerations and user preferences, the social media data can be gathered in a manner that ensures compliance with data policies and user consent. According to certain non-limiting examples, the social media data can be preprocessed, including, e.g., cleaning the data to remove irrelevant information, tokenizing text data, converting images to a compatible format, and categorizing hashtags and keywords. The compatible format can be a format that is used as an input to a machine learning (ML) model. For example, when the ML model is a transformer that accepts text, the image data can be converted to a text-based description of the semantic content of the image. Further, some ML models accept unstructured data, whereas other ML models can depend on the inputs being in a structured format, in which case preprocessing can include organizing or systematizing the information from unstructured data into a structured format.

Regarding the prediction model and training thereof, the systems and methods disclosed herein can train the ML model to generate profiles and/or gift recommendations based on the social media data. According to certain non-limiting examples, the prediction model can predict gift preferences directly from the social media data of the prospective recipients.

Alternatively, the prediction model can have multiple steps in which the outputs of one model are the inputs to another model. For example, a first model (e.g., one or more ML models) can output a profile based on the social media data associated with the gift recipient. The profile output from the first model can then be one of the inputs to a second model (e.g., one or more ML models) that generates the gift recommendations. The inputs to the second model can include, e.g., the profile of the gift recipient, purchasing information of the gift recipient, and/or a prompt (e.g., contextual information for the gift, such as what occasion prompted the gift, what is the relation between the user and the gift recipient, etc.).

According to a third alternative, the second model can output gift categories, which are an input to a third model (e.g., one or more ML models) that generates the gift recommendations. For example, the third model can use the gift categories from the second model together with the purchasing information of the gift recipient (e.g., their purchase history, brands in their wish list, etc.) to narrow/refine the field of options to provide particular gift recommendations.

According to certain non-limiting examples, the gift recommender system can include various models that analyze, organize, and summarize the semantic content conveyed by the gift recipient's social media in all its various forms (e.g., images, text, online interactions (likes, frequency of access, etc.), reposts, metadata, etc.) For example, gift recommender system can use one or more Natural Language Processing (NLP) models to analyze captions and comments to extract keywords, sentiments, and topics. Additionally or alternatively, the gift recommender system can include Named Entity Recognition (NER) models to identify specific entities such as brands, products, and interests. Additionally or alternatively, the gift recommender system can use image recognition models to analyze image content and identify objects, brands, activities, and contexts. The gift recommender system can also combine text and image data to create comprehensive profiles of prospective gift recipients, identifying preferences, interests, and behavior patterns.

According to certain non-limiting examples, the gift recommender system can include various prediction models that make predictions based on the information conveyed in the social media data. For example, the outputs from these prediction models can be predictions of what gifts or gift categories are wanted by the gift recipient. The inputs to these prediction models can be a profile of the gift recipient, the social media data, tokens generated by one or more of the data analysis/synthesis models discussed above.

According to certain non-limiting examples, the prediction model(s) used in the gift recommender system can include random forest models, support vector machine (SVM) models, deep learning models, recursive neural network (RNN) models, and transformer models. Further, the gift recommender system can include collaborative filtering models or content-based filtering models. For example, these models can be used to predict preferences and/or wanted gifts for the gift recipient. According to certain non-limiting examples, the prediction model(s) can generate personalized gift suggestions by mapping user preferences to potential gift categories. When historical purchasing data of the gift recipient is available the historical purchasing data can be used to refine gift categories.

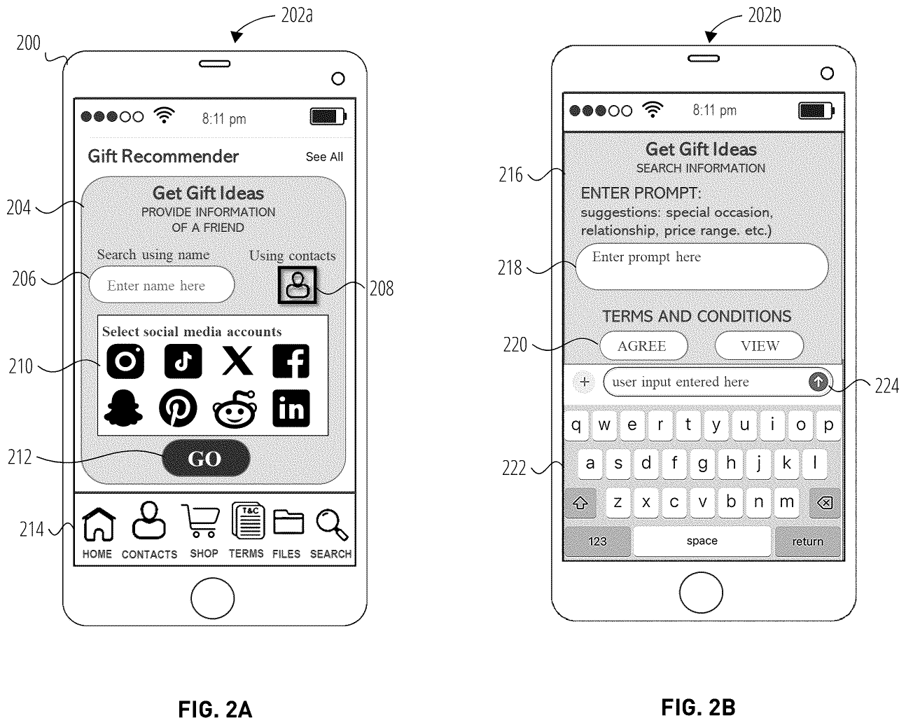

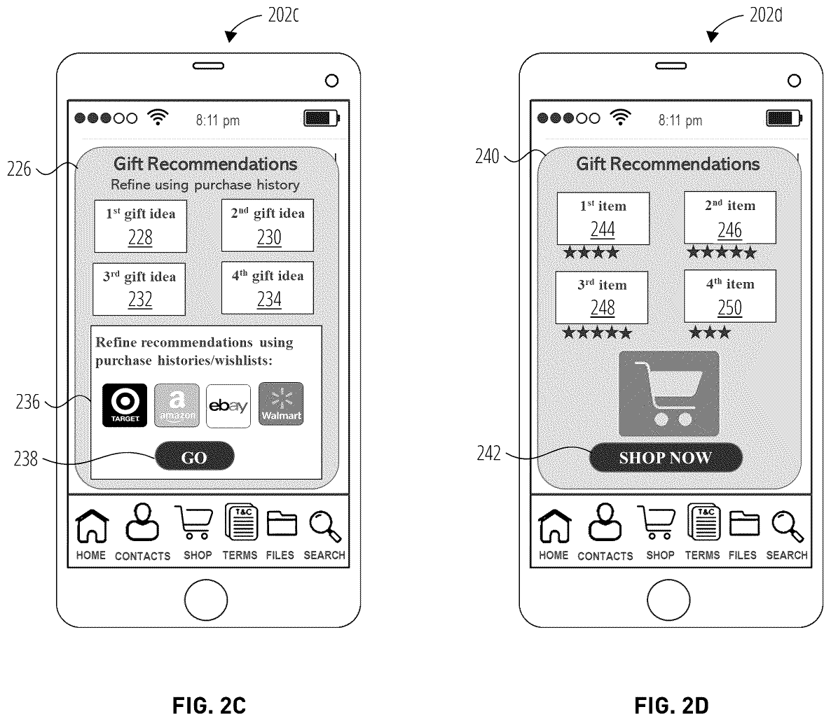

Regarding validation and deployment, the systems and methods disclosed herein can validate model predictions using a separate test dataset (e.g., holdout data 312). Based on the validation, the parameters/coefficients of the ML model can be adjusted to improve accuracy of the predictions and/or performance of the ML model. Regarding deployment, the ML model can be integrated into a user-friendly interface (e.g., website or mobile application) that provides real-time data processing and timely gift recommendations. For example, the ML model can be deployed, as illustrated in FIGS. 2A-D, using user interfaces 202a-d, which are respectively displayed on device 200.

Regarding continuous improvement, the systems and methods disclosed herein can use a feedback loop to collect user feedback on gift recommendations, and the user feedback can then be used for reinforcement learning to refine the ML model. Thus, the ML model can be continuously update with new data to maintain relevance and accuracy.

Regarding ethical considerations, the systems and methods disclosed herein can include features that enable the gift recommendation system to adhere to data privacy laws and guidelines (e.g., European Union's General Data Protection Regulation (GDPR) and the California Consumer Privacy Act (CCPA)). For example, these features can include anonymizing user data to protect identities. Additionally, the gift recommendation system can include features that provide transparency about data usage and obtain user consent, e.g., by informing users about data usage, obtaining consent, and providing options for users to opt out of data collection and analysis.

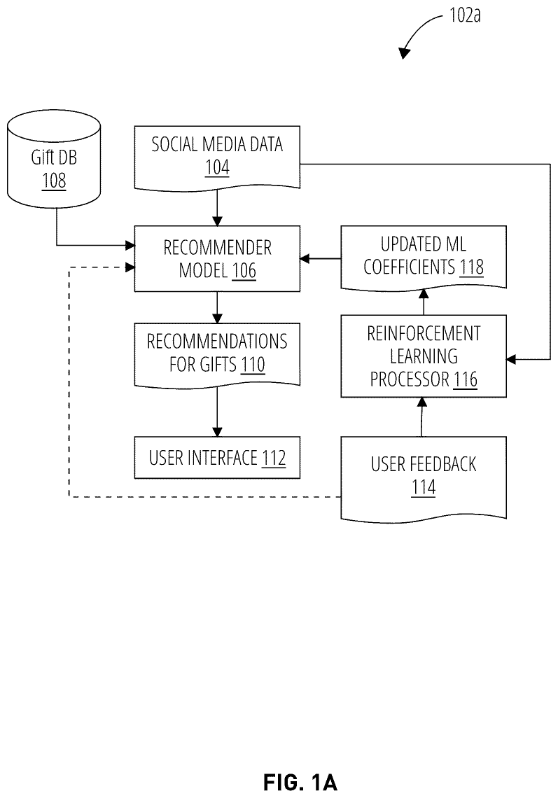

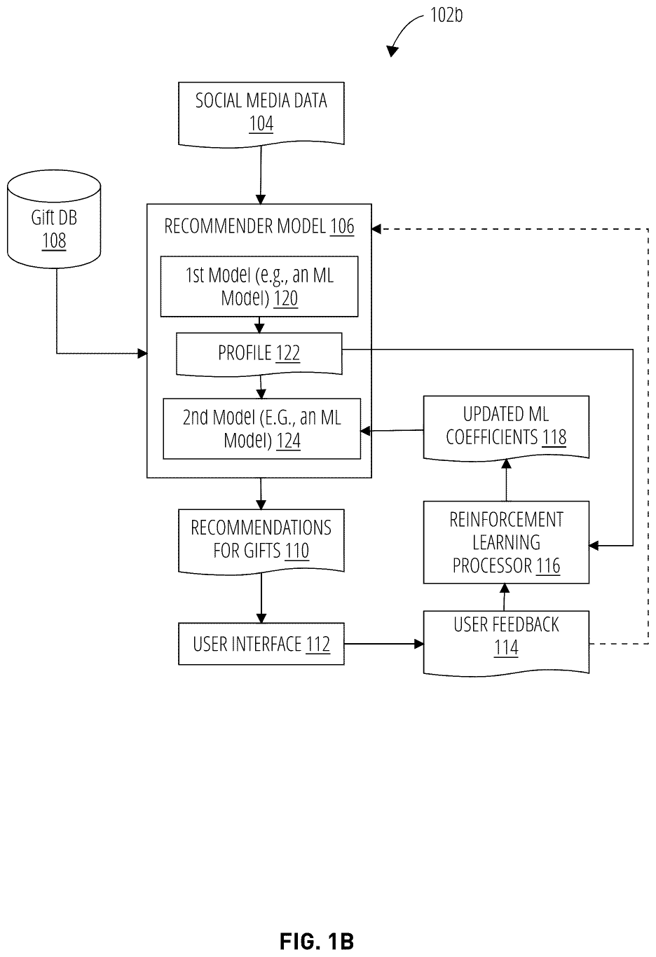

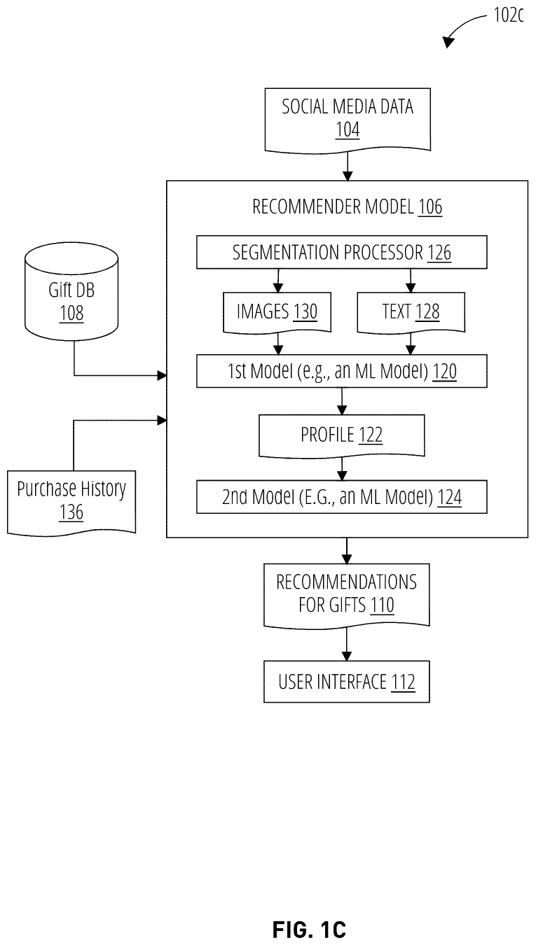

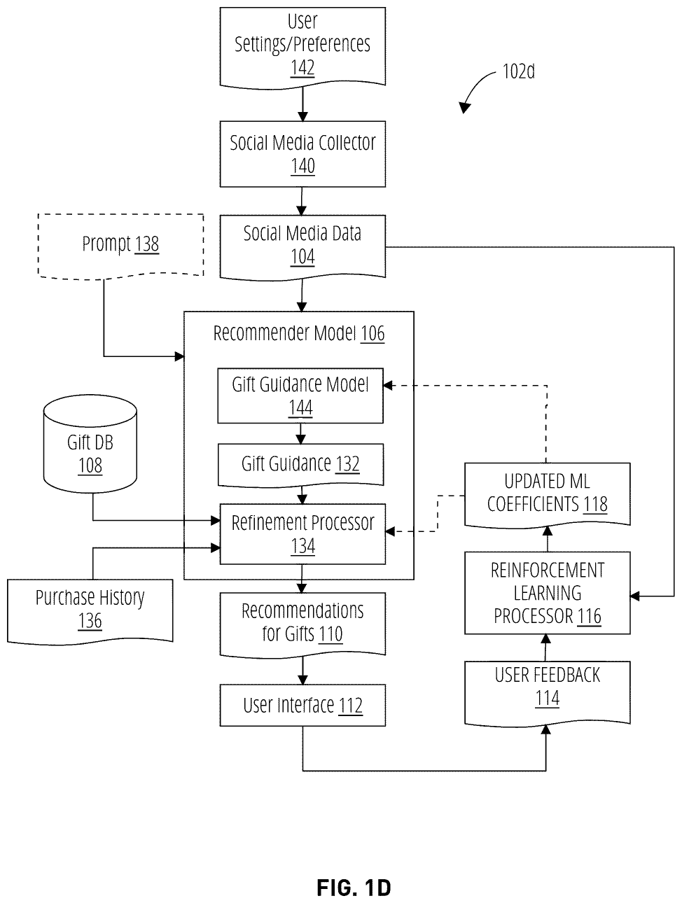

FIG. 1A illustrates system 102a, which provides gift recommendations (e.g., recommendations for gifts 110) based on social media data 104. System 102a aids gift-givers by recommending one or more gifts for a friend, a family member, an associate, an acquaintance, or a colleague (collectively referred to as gift recipient) based on the social media of the gift recipient. The recommended gifts are determined by applying the social media data 104 to recommender model 106 (e.g., a machine-learning (ML) model) which uses the context provided by the social media data 104 to predict the best gifts for the gift recipient (e.g., the most appropriate or best match based on the user social media activity).

According to certain non-limiting examples, the inputs received by recommender model 106 include social media data 104 and gift database 108, and, in response to these inputs, recommender model 106 generates recommendations for gifts 110. For example, recommender model 106 can be an artificial neural network (ANN) that has been trained to predict which gifts the gift recipient is likely to prefer based on the information that can be gleaned from the gift recipient's social media data 104. The recommendations for gifts 110 can be presented to gift-giver using a graphical user interface (e.g., UI 112). UI 112 can also monitor the response of the gift-giver to generate user feedback 114, which is then used by reinforcement learning processor 116 to perform reinforcement learning, generating updated ML coefficients 118 to improve and fine-tune recommender model 106.

According to certain non-limiting examples, recommender model 106 can include a machine learning (ML) model (e.g., a large language model (LLM)) which has been trained to receive collected social media posts of a gift recipient. The ML model then tokenizes and classifies the interests and aspects of the gift recipient as expressed in their social media to predict a closest match to the gift options in gift database 108, the gift options that are predicted to have the best match are then presented to gift-giver as gift recommendations. Using the trained ML model to recommend gifts can enable the users to select more meaningful gifts and save the user time.

According to certain non-limiting examples, the training data used to train the ML model is the same type of data as the data that will be used as the input to the trained ML model. For example, when social media data 104 applied to recommender model 106 includes text, images, and videos, then the input data in the training data will also include text, images, and videos. For example, the inputs to recommender model 106 can include likes, comments, reposting, images, image captions, other text, and videos from INSTRGRAM, FACEBOOK, TIK TOK, DSICORD, REDDIT and other social media sites, chat sites, messaged boards, blogs, e-commerce sites, or other Internet forums.

The training data can be labeled with human-generated gift preferences, such that supervised learning can be used to train recommender model 106. For example, human-generated gift preferences can be collected by monitoring the gifts selected for people with known profiles. These gift preferences can be based, e.g., on the people's stated preferences of gifts that they would like to receive (e.g., using gift wish lists generated by the people) or on gifts they have received (e.g., gifts and/or products that have been received by the people and for which the people provided positive feedback, such as in product reviews).

The labels can also include preferences with respect to gifts that people would not like to receive and preferences regarding gifts people are indifferent about receiving. For example, recommender model 106 can predict a continuous score representing a degree to which a gift recipient would like respective gifts. In this case, the labels can be continuous values representing an amount the people would like a gift. For example, the labels can be a value between 0 and 10, with o representing gifts that the person would least like to receive and 10 representing gifts that the person would most like to receive.

Alternatively, recommender model 106 can be classifier that classifies gifts into discrete categories one of which is gifts the gift recipient would like to receive. In this case, the labels can be discrete indicators (e.g., “yes” and “no”) representing a person would like a particular gift.

When the recommender model 106 includes an ANN, For example, a back projection algorithm can be used to train recommender model 106 using labeled training data and a loss function representing the proximity (e.g., calculated using a distance metric, such as the Euclidean distance) between the predicted result from recommender model 106 and the human-generated labels in the training data. The ML model can learn to classify best gift ideas based on the input social media data 104. Once trained, recommender model 106 enables users to quickly select appropriate/appreciated gifts for gift recipients.

According to certain non-limiting examples, reinforcement learning enables recommender model 106 to improve and to evolve and adapt as new products/gifts are introduced to the market. For example, when the IPOD was introduced to the market, recommender model 106 could quickly learn that user profiles that appreciated a WALKMAN as a gift would also appreciate an IPOD as a gift.

Recommender model 106 can continuously learn from human feedback through ongoing reinforcement learning. Often recommendations for gifts 110 are correct, and a user's actions in response to recommendations for gifts 110 can signal as such, resulting in user feedback 114. Other times, recommendations for gifts 110 will not be correct for the selected gift recipient. In such a case, gift-giver reviewing the incident can select a more appropriate gift resulting in user feedback 114.. Both types of user feedback 114 (i.e., confirmation of the recommendations for gifts 110 and selecting alternatives to the recommendations for gifts 110) can be used for reinforcement learning. Reinforcement learning can help recommender model 106 improve over time, and can also help recommender model 106 stay current.

For example, in many cases recommendations for gifts 110 can include false positives (e.g., recommended gifts that the user knows would not be appreciated by the gift recipient). In the case of false positives, the user can provide feedback indicating that the recommendation is a false positive. For example, UI 112 can allow users to tag respective gift recommendations with a thumbs up or a thumbs down, which can be used as user feedback 114. Additionally or alternatively, UI 112 can receive user inputs such as “more like this gift” or “less like this gift,” which can be used as user feedback 114. Additionally or alternatively, UI 112 can monitor what user actions are taken based on recommendations for gifts 110. For example, when a user buys a recommended gift, UI 112 can infer that as a true positive (i.e., that the recommendation was a gift that the user determined the user would like).

User feedback 114 can be used for reinforcement learning. According to certain non-limiting examples, user feedback 114 can also be used to update and refine the current recommendations. For example, when a user feedback is “more like this gift” or “less like this gift,” this new information can be used together with social media data 104 to provide better recommendations for gifts 110. The dashed line in FIG. 1B indicates an optional feedback process of providing user feedback 114 to recommender model 106 together with social media data 104 to generate new recommendations for gifts 110. This can be an iterative process until the user receive recommendations for gifts 110 that the user acts on to buy a gift, for example.

These gifts recommended by recommender model 106 are recommendations for gifts 110, which are presented/displayed to the gift-giver via a user interface (i.e., UI 112). By monitoring the gift giver's response to the gift recipient and recommendations for gifts 110 recommended by recommender model 106, UI 112 generated user feedback 114, which can be used for reinforcement learning. Because new products continue to be developed by manufacturers and preferences of people can evolve, recommender model 106 can also evolve to remain current by evolving to recommended recommendations for gifts 110. For example, teenage girls from 30 years ago may have liked music by the bands NSYNC, whereas teenage girls today may like the music of TAYLOR SWIFT. Thus, even though products and preferences evolve, recommender model 106 is still able to predict the current gift preferences for a gift recipient.

According to certain non-limiting examples, recommender model 106 can include one or more analysis models that analyze, organize, and/or summarize the semantic content conveyed by the gift recipient's social media in all its various forms (e.g., images, text, on-line interactions (likes, frequency of access, etc.), reposts, metadata, etc.) For example, analysis models used in recommender model 106 can include Natural Language Processing (NLP) models that analyze captions and comments to extract keywords, sentiments, and topics. Additionally or alternatively, analysis models used in recommender model 106 can include Named Entity Recognition (NER) that identify specific entities such as brands, products, and interests. Additionally or alternatively, recommender model 106 can use image recognition models to analyze image content and identify objects, brands, activities, and contexts.

Recommender model 106 can also combine text and image data to create comprehensive profiles of prospective gift recipients, identifying preferences, interests, and behavior patterns.

For example,

According to certain non-limiting examples, recommender model 106 can include one or more prediction models that make predictions based on the information conveyed in the social media data. For example, the outputs from these prediction models can be recommendations for gifts 110 (or gift guidance 132 in FIG. 1D). The inputs to these prediction models can be a profile of the gift recipient (e.g., profile 122), social media data 104, tokens generated using one or more of the data analysis/synthesis models discussed above.

According to certain non-limiting examples, the prediction model(s) used in recommender model 106 system can include random forest models, support vector machine (SVM) models, deep learning models, recursive neural network (RNN) models, transformer models. For example, Bidirectional Encoder Representations from Transformers (BERT) models, Generative pre-trained transformers (GPT), and T5 models have been demonstrated to effectively summarize and distill semantic meaning from text data. Further, the gift recommender system can include collaborative filtering models or content-based filtering models. For example, these models can be used to predict preferences and/or wanted gifts for the gift recipient. According to certain non-limiting examples, the prediction model(s) can generate personalized gift suggestions by mapping user preferences to potential gift categories. When historical purchasing data of the gift recipient is available the historical purchasing data can be used to refine gift categories, as discussed for FIG. 1C and FIG. 1D.

For example, content-based filtering can be realized using feature extraction of various items (e.g., to extract features of prospective gifts in gift database 108 and features of items the gift recipient is observed relating to/interacting with in social media data 104), generating representations of the various items, building a profile, and determining similarities between items the gift recipient appears to like (or not like). Feature extraction can include, e.g., identifying and defining the attributes or characteristics of items that can be used to make recommendations. Feature extraction of text-based data can include identifying keywords, topics, or genres. Techniques like Natural Language Processing (NLP) can be used to extract relevant features from text. Feature extraction can also include identifying categories, brands, or specifications of the items, and identifying numerical characteristics such as ratings or other measurable attributes.

Generating representations can include, e.g., generating vector space models of identified items. For vector space models, items can be represented as vectors in a feature space where each dimension corresponds to a feature. For textual items, techniques like Term Frequency-Inverse Document Frequency (TF-IDF) or word embeddings (e.g., Word2Vec, GloVe, etc.) are used to create these vectors. For non-textual data, items can be represented as vectors of numerical or categorical features. User profile can be built based on the features of items with which the gift recipient has interacted.

Determining similarities can include, e.g., determining a proximity between vectors in the user profile and feature vectors of prospective gifts. This proximity can be determined using a distance measure, such as, the cosine similarity, Euclidean distance, Jaccard similarity, or Pearson correlation. The prospective gifts can then be ranked by their similarity to the user profile, with the top N results (e.g., four results in FIG. 2D) provided to the user as recommendations for gifts 110.

According to certain non-limiting examples, recommender model 106 can ensure adherence user preferences and to data privacy laws and guidelines (e.g., European Union's General Data Protection Regulation (GDPR) and the California Consumer Privacy Act (CCPA)). For example, these features can include anonymizing user data to protect identities. Additionally, the gift recommendation system can include features that provide transparency about data usage and obtain user consent, e.g., by informing users about data usage, obtaining consent, and providing options for users to opt out of data collection and analysis.

For example, recommender model 106 realize data anonymization using, e.g., data masking, pseudonymization, generalization, and/or suppression. Data masking can include replacing sensitive data with a place holder that conveys the semantic meaning but is not sensitive. Pseudonymization can include replacing sensitive fields within a database with pseudonyms or tokens. the actual data can be re-identified only through a separate mapping table that is kept secure. For example, replacing user ids with anonymized tokens. Generalization can reduces the precision of data to prevent re-identification while maintaining most of the semantic meaning (e.g., replacing specific ages with age ranges (e.g., 30-40) or replacing exact locations with broader geographic areas). Suppression can include identifying sensitive fields within the data and replacing them with pseudonyms or tokens that preserve the relevant semantic meaning (e.g., replacing user ids with anonymized tokens).

FIG. 1B illustrates a non-limiting example of system 102b, which is the same as system 102a, except that recommender model 106 explicit uses two models (e.g., first model 120 and second model 124) to generate recommendations for gifts 110.

According to certain non-limiting examples, recommender model 106 includes an intermediate step of first generating a profile of the gift recipient, and then using the profile and a database of possible gifts to determine which gifts best match the profile. The profile can represent the user's interests and demographic based on the gift recipient's engagement with social media. According to certain non-limiting examples, an ML model can learn the correlations and patterns between gift preferences and various profile types, and these learned correlations can be used to predict the preferred gifts for a person with the gift recipient's profile. For example, the profile can be used to predict which gifts would be the most appropriate/appreciated by the gift recipient.

Reinforcement learning processor 116 can improve the gift predictions by second model 124 using reinforcement training data to continuously improve second model 124. The reinforcement training data can include training inputs (i.e., profiles 122 which are input to second model 124) and training outputs/labels (e.g., based on user feedback 114). When second model 124 is an ANN, the reinforcement training data is used to update the weighting coefficients between two or more layers of the neural network to minimize a loss function, as described above.

FIG. 1B illustrates a non-limiting example of system 102c. Like system 102b, recommender model 106 includes first model 120 and second model 124. First model 120 generates profile 122 based on social media data 104, and second model 124 generates recommendations for gifts 110 based on profile 122. In contrast to system 102b, system 102c also explicitly includes segmentation processor 126, images 130, text 128, and purchase history 136.

The segmentation processor 126 receives the social media data 104 and generates therefrom segmented elements, including text 128 and images 130. As discussed above, the text 128 can include text in various forms such as comments, blog posts, product reviews, and figure captions.

Social media data 104 can be segmented using various methods and techniques, such as semantic segmentation models, which include Fully Convolutional Network (FCN) methods, U-Net methods, SegNet methods, a Pyramid Scene Parsing Network (PSPNet) methods, and DeepLab methods. The segmentation processor 126 can also segment the social media data 104 using image segmentation models, such as Mask R-CNN, GrabCut, and OpenCV. The segmentation processor 126 can also segment the social media data 104 using Object Detection and Image Segmentation methods, such as fast R-CNN methods, faster R-CNN methods, You Only Look Once (YOLO) methods, PASCAL VOC methods, COCO methods, and ILSVRC methods. The segmentation processor 126 can also segment the social media data 104 using Single Shot Detection (SSD) models, such as Single Shot MultiBox Detector methods. The segmentation processor 126 can also segment the social media data 104 using detection transformer (DETR) models such as Vision Transformer (ViT) methods.

Many of the above methods identify the objects within the segmented elements, but, for other segmentation methods, a separate step is used to identify the object depicted in the segmented elements. This identification step can be performed using a classifier method or a prediction method. For example, identifying images 130 can be performed using an image classifier, such as K-means methods or Iterative Self-Organizing Data Analysis Technique (ISODATA) methods. The following methods can also be trained to provide object identification capabilities for segmented images: YOLO methods, ResNet methods, ViT methods, a Contrastive Language-Image Pre-Training (CLIP) methods, convolutional neural network (CNN) methods, MobileNet methods, and EfficientNet methods.

For text 128, a two-step process can be used in which optical character recognition is used, e.g., to map a segment with text to an order set of alphanumeric characters (e.g., an ASCII character string of the text), and then a language model is applied to determine the referent or the type referent that is referred to by the text. For example, a natural language processing (NLP) model or large language model (LLM) can be used such as a transformer method, a Generative pre-trained transformers (GPT) method, a Bidirectional Encoder Representations from Transformers (BERT) method, or a T5 method.

The segmented elements (i.e., text 128 and images 130) are received by first model 120. Further, first model 120 can also receive metadata from social media data 104.

System 102c also uses purchase history 136 and gift database 108 to generate recommendations for gifts 110. For example, when the gift recipient's e-commerce accounts can be accessed, purchase history 136 can be generated based on the gift recipients verified purchases, product reviews, items in the gift recipient's shopping cart or wish lists. Even when a gift recipient's purchase history is not accessible, the gift recipient may still have publicly accessible wish lists on various e-commerce sites. Thus, purchase history 136 can more generally be described as the gift recipient's shopping information (e.g., purchasing histories, wish lists, product reviews, etc.), This shopping information can include, e.g., which categories of items and which brands the gift recipient tends to want, like, purchase, and/or highly rate/review.

According to certain non-limiting examples, purchase history 136 can be included in the inputs to first model 120 to generate profile 122. Additionally or alternatively, purchase history 136 can be included in the inputs to second model 124 to generate recommendations for gifts 110.

In contrast to FIG. 1A and FIG. 1B, FIG. 1C does not explicitly show a reinforcement training loop, but system 102c can include a reinforcement training loop. Further, the elements of systems in any of FIG. 1A, FIG. 1B, FIG. 1C, and FIG. 1D can be combined.

FIG. 1D illustrates system 102d, which includes social media data 104, recommender model 106, gift database 108, recommendations for gifts 110, UI 112, user feedback 114, reinforcement learning processor 116, updated ML coefficients 118, gift guidance 132, refinement processor 134, purchase history 136, prompt 138, social media collector 140, user settings/preferences 142, and gift guidance model 144.

Social media data 104, recommendations for gifts 110, UI 112, user feedback 114, reinforcement learning processor 116, and updated ML coefficients 118 can be as described in FIG. 1A, FIG. 1B, FIG. 1C, or any combination thereof. Recommender model 106 can be modified with respect to implementations discussed above in that gift guidance model 144 performs many of functions of recommender model 106, except gift guidance model 144 generates gift guidance 132, rather than recommendations for gifts 110. Refinement processor 134 then receives gift guidance 132 and generates recommendations for gifts 110. Gift guidance 132 can be, e.g., recommended categories of gifts that the gift recipient would appreciate receiving. Then refinement processor 134 can refine/narrow the recommendation from recommended categories to recommended gifts in recommendations for gifts 110. According to certain non-limiting examples, refinement processor 134 can be an ML modes that is trained to receive as inputs gift guidance 132, gift database 108, and purchase history 136, and, in response to these inputs, refinement processor 134 generated recommendations for gifts 110.

Recommender models 106 can include one or more ML models that use as inputs prompt 138 and social media data 104 to generate gift guidance 132. Prompt 138 can allow the user to provide contextual information, such as the impetus for the gift (e.g., a holiday, birthday, special event, etc.) or relationship to the gift recipient, that guides which gift recommendations would be appropriate. For example, the prompt can be a plain text/prose description of the context for the gift giving occasion, or the prompt can be a series of key words (e.g., terms typed in by the user or selected using drop down menus, radio buttons, etc.). Examples of helpful contextual information can include, e.g., a special occasion, a relationship to the gift recipient, a price range, a desired result, or any other information that is likely to be helpful in narrowing the scope of possible gifts and provide more targeted recommendations. For example, given the same profile, an input of “anniversary gift for my romantic partner on our 2nd wedding anniversary” is likely to produce different recommendations than “baby shower gift for my daughter in-law having a baby girl.”

Recommender models 106 can include gift guidance model 144 that generates gift guidance 132. According to certain non-limiting examples, gift guidance 132 can also be generated based on prompt 138 and a profile of the gift recipient that is generated based on social media data 104. Gift guidance 132 can be informative to signal to the user which categories are being prioritized based on the gift recipient's profile. According to certain non-limiting examples, gift guidance 132 can be presented to the user, e.g., via UI 112, and user feedback can be received indicating whether gift guidance 132 includes false positives or true positives. For example, gift guidance can include respective gift categories, and, upon selecting one of these categories, the user can select a thumbs up or thumbs down indicating a true positive or a false positive, respectively. This user feedback can then be used for reinforcement learning to improve recommender model 106.

Additionally or alternatively, UI 112 can generate user feedback 114 based on user interactions with recommendations for gifts 110, as discussed above. User feedback 114 can be used to improve refinement processor 134 and/or gift guidance model 144. For example, when refinement processor 134 includes an ML model, user feedback 114 can be used to improve the ML model of refinement processor 134. Alternatively, user feedback 114 can be used to improve an ML model in gift guidance model 144 (e.g., second model 124).

System 102d also includes social media collector 140 and user settings/preferences 142. A user can select preferences with respect to data privacy, whether to allow cookies to be stored on their computer, provide permissions for 102d to access information stored by third parties (e.g., the user's information stored on e-commerce websites). User settings/preferences 142 can also include indicia that the user has agreed to respective terms and conditions. Social media collector 140 then collects social media data 104 while complying with the user's stated preferences and settings with respect to data privacy, permission, etc. Information in user settings/preferences 142 can be encoded in metadata that propagates throughout system 102d to ensure that the user's setting/preferences are complied with not only by social media collector 140 but also gift guidance model 144 and refinement processor 134.

For example, a user's setting/preferences can include whether personal identifiable information (PII) is stored and where it is stored. For example, one or more blocks of systems 102a-d can be performed partly or entirely in the cloud (e.g., on a remote server) and the reminder can be performed on the user's personal device (e.g., a client device). Additionally, some of the data of systems 102a-d can be stored remotely (e.g., on the remote server) with the remainder being stored locally (e.g., on the client device).

For example, based on user settings/preferences 142, personal identifiable information (PII) can be stored locally, and only tokenized or anonymized information sent to the server. For example, images and text of the socially media can be stored on the client device and tokenized on the client device, The generated tokens can represent the semantic content of the images and text without PII. For example, semantic segmentation models can identify the contents in an image and the relations among the contents without including PII (e.g., names) of the people depicted in the image. The tokens representing the semantic content of the social media data 104 can then be passed to the remote server, where a profile and/or gift guidance 132 (or recommendations for gifts 110) are generated based on the tokens. Thus, system 102d can ensure that PII is not transferred from the client device, thereby ensuring data privacy.

FIG. 2A illustrates an example of device 200 displaying a first screen user of a gift recommender application (i.e., user interface 202a) that includes, among other things, an info request panel 204, name request text input 206, contact access button 208, social media selection input 210, go button 212, and short cut menu 214.

Responsive to the user selecting the gift recommender application, device 200 can transition to the first user interface (e.g., user interface 202a), which is illustrated in FIG. 2A. User interface 202a can include short cut menu 214 and info request panel 204. Short cut menu 214 allows a user to quickly move between sections of the application.

Info request panel 204 can include name request text input 206, contact access button 208, social media selection input 210, and go button 212. Info request panel 204 provides instructions to the user to input recipient ID information that identifies a gift recipient for whom gift recommendation's are requested. The recipient ID information can be obtained either by entering text in name request text input 206 or using contact access button 208 to retrieve an existing contact from a contacts application. This example for obtaining recipient ID information is non-limiting, and other ways of generating the recipient ID information can be used. The recipient ID information can include a name and information (e.g., images of the gift recipient, a data of birth, affiliated institutions, current and/or previous residential addresses, current and/or previous phone numbers, email addresses, etc. ,). The recipient ID information can be collected using connections with the gift recipient indicated on the users social media (e.g., the recipient ID information can be gleaned from the user's connections in LINKEDIN or FACEBOOK).

Social media selection input 210 can be used to provide guidance regarding on what social media platforms the gift recipient has accounts and what are the gift recipient's account names/handles on the respective social media platforms. The gift recipient's social-media accounts can then be mined to generate a user profile of the gift recipient. According to certain non-limiting examples, the recipient ID information can be used to find likely social media accounts corresponding to the gift recipient, and the user can click through and review the likely social media accounts corresponding to the gift recipient to confirm whether or not they are associated with the gift recipient. According to certain non-limiting examples, the icons of social media platforms can be greyed out for social media platforms for which there are not found any likely social-media accounts corresponding to the gift recipient. According to certain non-limiting examples, the user can manually enter social media accounts corresponding to the gift recipient.

Once the recipient ID information and the social media account information has been received through info request panel 204, the user can select go button 212, causing the gift recommender application to generate a user profile and to transitions from user interface 202a to user interface 202b.

According to certain non-limiting examples, social media selection input 210 can be omitted, and the gift recommender application can automatically find social-media accounts corresponding to the recipient ID information.

User interface 202b, which is illustrated in FIG. 2B, allows the user to enter text describing a prompt using keyboard 222. The user enters the text using keyboard 222, and the text shows up in the text entry field 224 (i.e., the oval showing the text “user input entered here”). When the user touches the up arrow in the text entry field 224, the text shows up in a text display bubble, such as text display bubble 218. Prompt request panel 216 includes instructions (e.g., the text “ENTER PROMPT: suggestions: special occasion, relationship, price range, etc.”) the guide a user regarding the types of text-based information that is helpful to narrow the scope of possible gifts and provide more targeted recommendations. For example, an input of “anniversary gift for my romantic partner on our 25th wedding anniversary” is likely to produce different recommendations than “baby shower gift for my daughter in-law having a baby girl.”

Legal consideration buttons 220 can be used for administrative task and handling legal compliance. According to certain non-limiting examples, these can also include drop down selection menus or other input elements that allow users to personalize user preferences (e.g., preferences regarding privacy, cookie policies, and what information can be shared by third parties).

In various instances, user interfaces incorporate customizable features to cater to individual preferences. Drop-down selection menus and other input elements are commonly employed to facilitate this personalization process. For example, users may be presented with a drop-down menu when configuring their privacy settings on an online platform. This menu could offer options such as “Always allow,” “Only for specific sites,” or “Never allow.”

Similarly, cookie policies can also be adjusted through user input. A user might choose to accept all cookies (which may help enhance site functionality and personalization), decline non-essential cookies, or block all cookies altogether.

Furthermore, users have the ability to control what type of information they share with third parties. This could involve selecting which categories of data are permissible for external use, such as demographic details (name, age, location), behavioral patterns (browsing history, purchase preferences), or personal identifiers (email address).

By providing these customizable options, platforms can create a more user-centric experience while maintaining transparency and control over data usage.

FIG. 2C illustrates a user interface 202c display by device 200. User interface 202c includes refinement request panel 226, which includes shopping history request box 236 and several gift categories (e.g., a first gift category 228, a second gift category 230, a third gift category 232, and a fourth gift category 234). The gift categories can be generated, e.g., based on the user profile of the identified gift recipient.

According to certain non-limiting examples, the gift categories can also be generated based on the prompt that has been entered in the prompt request panel 216. According to certain non-limiting examples, the gift categories can be informative to signal which categories are being prioritized based on the gift recipient's user profile.

Alternatively, the gift categories can be used to provide user feedback regarding which gift categories the user subjectively believes are more appropriate or better fits based on the user knowledge of for the gift recipient's interests. For example, one or more of the displayed gift categories can be given a thumbs up (e.g., liked) and one or more other gift categories can be given a thumbs down (e.g., disliked). This user feedback can be used to improve the gift recommendations based on the additional information provided by the user (e.g., which categories are liked or disliked). Additionally, this user feedback and other user feedback can be used for reinforcement learning to improve machine learning models that are used to generate various predictions of the gift recommender application.

According to certain non-limiting examples, the gift categories can be omitted from refinement request panel 226. For example, the gift recommender application can directly use the user profile of the friend and the shopping information (e.g., purchasing histories, wish lists, etc.) of the friend to directly predict the gifts recommendations without the intermediate step of predicting the gift categories.

Shopping history request box 236 allows the user to select one or more e-commerce retailer from which to user the gift recipient's purchase histories, publicly accessible wish lists, liked items, and/or recently viewed items when generating the gift recommendations. Shopping history request box 236 can enable a user to select which e-commerce retailers to review for shopping information. Additionally or alternatively, shopping history request box 236 can enable user to identify which user accounts on the respective e-commerce retailers are associated with the gift recipient,

Go button 238 signal to the gift recommender application that the user inputs have been entered, and the gift recommender application can execute the subsequent processes (e.g., predict gift recommendations based on the provided information). Further, selecting go button 238 causes the gift recommender application to transitions from user interface 202c to user interface 202d.

FIG. 2D illustrates a user interface 202d that displays the gift recommendations (e.g., a first recommendation 244, a second recommendation 246, a third recommendation 248, and a fourth recommendation 250). The number of stars below the gift recommendations can indicate an average value for the customer reviews.

User interface 202d can also enable a user to view, for one or more of the gift recommendations, available items for purchase. For example, a user can select one of the gift recommendations and select the shop now button 242 to see which e-commerce retailers have items in stock corresponding to the selected gift recommendation and to compare the advertised prices for the items in stock.

Further, the gift recommender application can interface with e-commerce websites to enable purchasing directly from the application, and the gift recommender application can monitor what items the user actually purchases for the gift recipient (e.g., by noting whether gift wrapping is selected for the item or whether the item ship to an address of the gift recipient). The information generated by monitoring the users behavior post gift recommendations can be used to generate user feedback that is used for reinforcement learning. Additionally or alternatively, the gift recommender application can allow users to manually enter user feedback, which is used for reinforcement learning.

FIG. 2A, FIG. 2B, FIG. 2C, and FIG. 2D illustrate a non-limiting example of a user interface for using generative AI and social media data to predict gift recommendations. A person of ordinary skill in the art would understand that other user interfaces can be used to realize The systems and methods disclosed herein. For example, FIG. 2A, FIG. 2B, FIG. 2C, and FIG. 2D illustrate an application implemented on a user device 200, such as a smart phone. Additionally or alternatively, the user interface can be implemented on an electronic reading device(e-reader), tablet, laptop, or desktop computer. For example, the user interface can be executed using software that has been downloaded and executed locally on a smartphone, a tablet, or a computer on which an application or software. According to certain non-limiting examples, the software includes instructions and/or functionality that is performed in a cloud computing environment (e.g., software as a service (SaaS)). Additionally or alternatively, the user interface can be a webpage that is displayed using web browser displayed on a monitor or display of a computer. The web browser can be used to access a website or content provider that displays the website executing the gift recommender application within the web browser or an application.

Devices implementing the gift recommender application can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

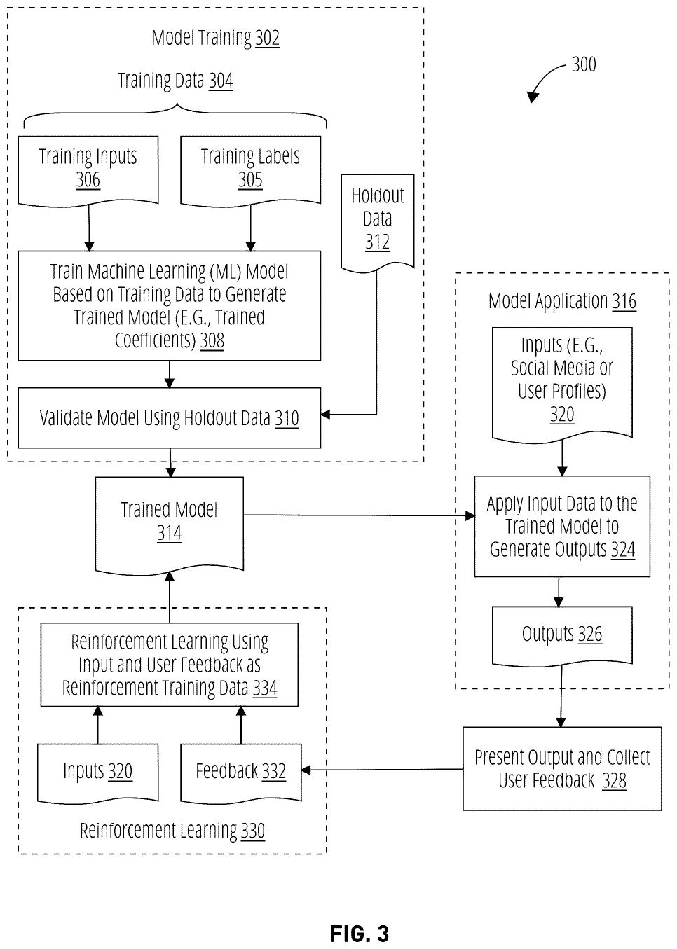

FIG. 3 illustrates an example of training a machine learning (ML) model to generate trained model 314 to which inputs 320 are applied to generate outputs 326. FIG. 3 also illustrates using reinforcement learning 330 to improve trained model 314 based on feedback 332. Method 300 includes three parts: (1) model training 302; (2) model application 316; and (3) reinforcement learning 330.

In model training 302, training data 304 is applied to train the ML model. For example, the ML model can be an artificial neural network (ANN) that is trained via supervised or unsupervised learning using a backpropagation technique to train the weighting parameters between nodes within respective layers of the ANN. Alternatively or additionally, the ML model can include other models, such as a random forest model, a linear regression model, a boosted trees model, a non-linear regression model, and/or a support vector machine, for example. Without loss of generality, the method 300 is illustrated using the non-limiting example of the ML model being an ANN.

In supervised learning, the training data 304 is labeled such that the training data 304 includes training inputs 306 (e.g., historical data including social media data of respective gift recipients, or profiles of the respective gift recipients) associated with training labels 305 (e.g., historical data representing gifts that were desired by the respective gift recipients). The inputs in the training data 304 are applied to the ML model, and an error/loss function is generated by comparing the output from the ML model with the desired outputs/labels of the training data 304 (e.g., gifts that are desired by the respective gift recipients). Starting with the training inputs 306, the coefficients of the ML model are iteratively updated to reduce an error/loss function. The value of the error/loss function decreases as outputs from the ML model increasingly approximate the desired output. In other words, ANN infers the mapping implied by the training data, and the error/loss function produces an error value related to the mismatch between the desired output and the outputs from the ML model that are produced as a result of applying the training data 304 to the ML model.

Alternatively, for unsupervised learning or semi-supervised learning, training data 304 is applied to train the ML model. For example, the ML model can be an artificial neural network (ANN) that is trained via unsupervised or self-supervised learning using a backpropagation technique to train the weighting parameters between nodes within respective layers of the ANN.

In unsupervised learning, the training data 304 is applied as an input to the ML model, and an error/loss function is generated by comparing the predictions to other data in the training data 304 For example, in time series or prose (ordered words), the ML model can predict the next value in the series based on the previous values, and the error function is generated by comparing the predicted next value in a series to the actual next value in the series. The coefficients of the ML model can be iteratively updated to reduce an error/loss function. The value of the error/loss function decreases as outputs from the ML model increasingly approximate the training data 304.

Relatedly generative adversarial networks (GAN) can be trained using unlabeled training data and unsupervised learning by pitting two ML models (a generative ML model and a classifying ML model) against each other to train the ML models.

In certain implementations, the cost function can use the mean-squared error to minimize the average squared error. In the case of a of multilayer perceptrons (MLP) neural network, the backpropagation algorithm can be used for training the network by minimizing the mean-squared-error-based cost function using a gradient descent method.

Training a neural network model essentially means selecting one model from the set of allowed models (or, in a Bayesian framework, determining a distribution over the set of allowed models) that minimizes the cost criterion (i.e., the error value calculated using the error/loss function). Generally, the ANN can be trained using various algorithms for training neural network models (e.g., by applying optimization theory and statistical estimation).

For example, the optimization method used in training artificial neural networks can use some form of gradient descent, using backpropagation to compute the actual gradients. This is done by taking the derivative of the cost function with respect to the network parameters and then changing those parameters in a gradient-related direction. The backpropagation training algorithm can be: a steepest descent method (e.g., with variable learning rate, with variable learning rate and momentum, and resilient backpropagation), a quasi-Newton method (e.g., Broyden-Fletcher-Goldfarb-Shannon, one step secant, and Levenberg-Marquardt), or a conjugate gradient method (e.g., Fletcher-Reeves update, Polak-Ribiére update, Powell-Beale restart, and scaled conjugate gradient). Additionally, evolutionary methods, such as gene expression programming, simulated annealing, expectation-maximization, non-parametric methods and particle swarm optimization, can also be used for training the ML model.

In process 310, method 300 can also include various techniques to prevent overfitting to the training data 304 and for validating the trained process 324. For example, holdout data 312 can be used in process 310 to validate the trained ML model. The holdout data 312 can be a subset of the training data 304 that was not used in process 308, but was instead set aside to be used for validation. Additionally or alternatively, validation can be performed using bootstrapping and random sampling of the training data 304 can be used.

As understood by those of skill in the art, other methods can be used for the ML model including one or more of the following: hidden Markov models, recurrent neural networks (RNNs), convolutional neural networks (CNNs); Deep Learning networks, Bayesian symbolic methods, generative adversarial networks (GANs), support vector machines. As discussed above, the ML model can include a regression algorithms, such as, but not limited to, a Stochastic Gradient Descent Regressors, and/or Passive Aggressive Regressors, etc.

The ML models can also include one or more clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, the ML model can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

In process 324, inputs 320 can be applied to the trained ML model (e.g., an ANN with the trained model 314) to generated the outputs 326.

In process 328, feedback 332 is generated for outputs 326. For example, outputs 326 can be presented to a user via a user interface (UI), and the user can provide indicia whether outputs 326 is correct (e.g., whether outputs 326 is a true positive or a false positive). Feedback 332 together with inputs 320 can be used as reinforcement training data to improve and update trained model 314. process 334 is performed similarly to process 308, except the training data is augmented to include the reinforcement training data. For example, the contribution to the loss function due to the reinforcement training data can be weighted more than the original training data (e.g., training data 304).

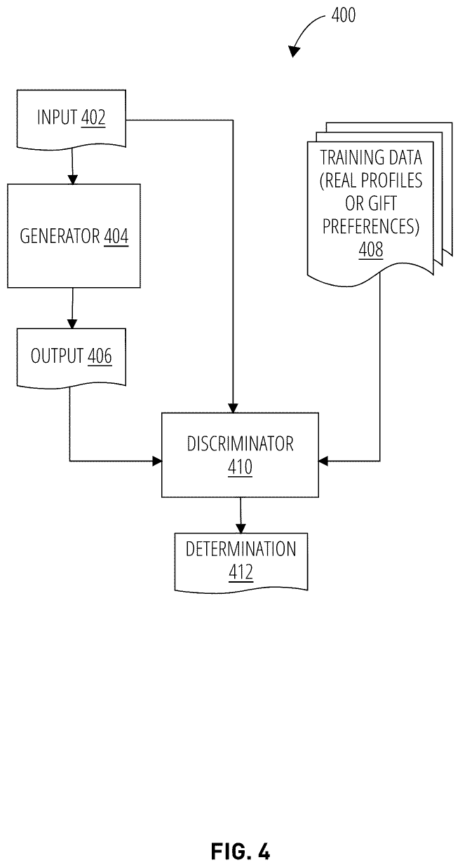

Additionally, some of the ML models in systems 102a-d can be generative adversarial networks (GANs) that are trained using unsupervised learning. FIG. 4 illustrates a GAN architecture 400. The GAN architecture 400 has two parts: the generator 404 and the discriminator 410. The generator 404 learns to generate plausible profiles (or gift recommendations) from social media data. The discriminator 410 learns to distinguish a plausible profile from the generator 404 from a real profile from a corpus of training data that includes profiles associated with social media data. In this discrimination, the discriminator 410 can use the social media data in addition to the real profile and the generated profile. The discriminator 410 receives profiles (i.e., the output 406 from the generator 404 and a real profile from the training data 408), and analyzes the two profiles to make a determination 412 which is the real profile. The generator 404 fools the discriminator 410 when the determination 412 is incorrect regarding which of the profiles received by the discriminator 410 was real.

Both the generator and the discriminator are neural networks with weights between nodes in respective layers, and these weights are optimized by training against the training data 408, e.g., using backpropagation. The instances when the generator 404 successfully fools the discriminator 410 become negative training examples for the discriminator 410, and the weights of the discriminator 410 are updated using backpropagation. Similarly, the instances when the generator 404 is unsuccessfully in fooling the discriminator 410 become negative training examples for the generator 404, and the weights of the generator 404 are updated using backpropagation.

When the GAN architecture 400 is used to train the first model 120, input 402 can be social media data 104 or tokens summarizing the content of social media data 104, which generates a profile as the output 406. Once trained, generator 404 would then be used as first model 120.

Alternatively, training data 408 can be social media data and output 406 from generator 404 can be plausible social media data that is generated based on a profile as input 402. Discriminator 410 can generate profiles from the real social media data and the generated social media data, and determination 412 can be based on a comparison with the original profile used as input 402. Discriminator 410 would then be used as first model 120.

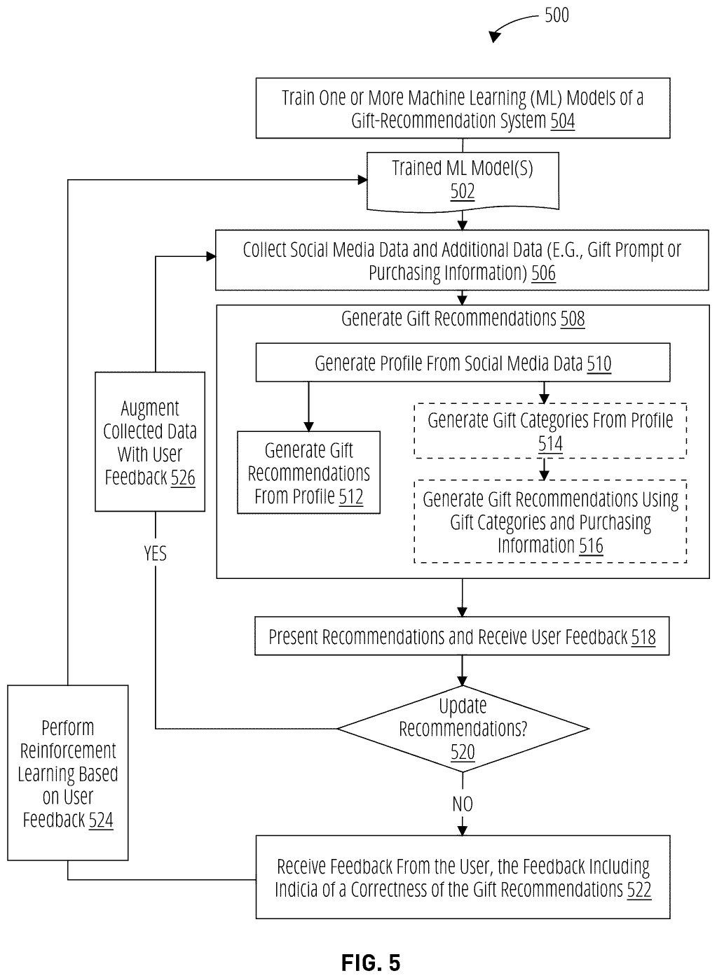

FIG. 5 illustrates an example method 500 for generating gift recommendations based on social media data 104 of a prospective gift recipient. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

According to some examples, the method includes training one or more machine learning (ML) models of a gift-recommendation system at step 504. For example, the recommender model 106 illustrated in FIG. 1A may train one or more machine learning (ML) models of a gift-recommendation system. The gift-recommendation system (e.g., systems 102a-d) can include one or more ML models (e.g., first model 120, second model 124, and/or refinement processor 134 can include an ML model). The respective ML models in the system are trained in accordance with model training 302 in FIG. 3 and/or GAN architecture 400 in FIG. 4, resulting in trained ML model(s) (e.g., trained model 314).

According to some examples, in step 504, the method includes training machine-learning (ML) model on training data. For example, the training data can be labeled training data that is used for supervised learning. Step 504 can train ML models used in first model 120, second model 124, and/or refinement processor 134 illustrates in in FIG. 1A, FIG. 1B, FIG. 1C, and FIG. 1D for example.

According to certain non-limiting examples, the machine-learning model can be an artificial neural network in which weighting coefficients between respective layers are used to combine values of nodes at a layer to generate values at nodes of a subsequent layer in the artificial neural network. Training the ML model can includes adjusting the weighting coefficients between one or more layers of the artificial neural network to minimize a loss function representing a difference/proximity between the training data gift recommendations (or training data profiles) and an output of the machine-learning model in response to applying the training data inputs.

When the ML model(s) includes an ANN, For example, a back projection algorithm can be used to train an ML model using labeled training data and a loss function representing the proximity (e.g., calculated using a distance metric, such as the Euclidean distance) between the predicted output (e.g., a profile or gift recommendations)and the human-generated labels in the training data.

According to some examples, the method includes collecting social media data and additional data (e.g., gift prompt or purchasing information) at step 506. For example, the social media collector 140 illustrated in FIG. 1D may collect social media data and additional data (e.g., gift prompt or purchasing information). Step 504 and/or step 506 can be performed as described for social media collector 140 in FIG. 1D.

According to some examples, the method includes generating gift recommendations at process 508. For example, the recommender model 106 illustrated in FIG. 1A may generate gift recommendations. Process 508 receives social media data 104 and generates recommendations for gifts 110. Process 508 can be performed as described with respect to recommender model 106 and refinement processor 134 in FIG. 1A, FIG. 1B, FIG. 1C, and FIG. 1D, or any combination thereof. As illustrated in FIG. 1A and FIG. 1D, recommender model 106 can generate recommendations for gifts 110 without necessarily generating an intermediate result of profile 122. Alternatively, FIG. 1B and FIG. 1C include a first model 120 that generates profile 122 (corresponding to step 510). Further, FIG. 1B and FIG. 1C include second model 124 generates recommendations for gifts 110 from profile 122 (corresponding to step 512). System 102d in FIG. 1D illustrates an implementation that includes step 514 and step 516. For example, recommender model 106 can perform step 514, and refinement processor 134 can perform step 516. In FIG. 5 step 512 is represented as an alternative to step 514 and step 516. Additionally, step 514 and step 516 can be performed with or without performing step 510. For example, step 514 can generate the gift categories directly from social media data 104 without the intermediate result of generating profile 122.

According to some examples, the method includes generating profile from social media data at step 510. For example, the first model 120 illustrated in FIG. 1B may generate profile from social media data.

According to some examples, the method includes generating gift recommendations from profile at step 512. For example, the second model 124 illustrated in FIG. 1B may generate gift recommendations from profile.

According to some examples, the method includes generating gift categories from profile at step 514. For example, the recommender model 106 illustrated in FIG. 1A may generate gift categories from profile.

According to some examples, the method includes generating gift recommendations using gift categories and purchasing information at 134 516. For example, the refinement processor 134 illustrated in FIG. 1D may generate gift recommendations using gift categories and purchasing information.

According to some examples, the method includes presenting recommendations and receive user feedback at step 518. For example, the UI 112 illustrated in FIG. 1A may present recommendations and receive user feedback.

For example, in step 518, recommendations for gifts 110 can be presented to the user and recording the user's response to the recommendations. Step 518 can be performed, e.g., using UI 112, and this step can be performed using the techniques and processes described with reference to UI 112.

Further, step 518 can include receiving feedback from gift-giver, which includes indicia whether the recommended gifts were appropriate for the gift recipient.

According to some examples, in decision block 520, the method queries whether to update recommendations for gifts 110 based on user feedback 114. When it is determined to update recommendations for gifts 110, the method returns to step 506 via step 526. Otherwise, method 500 continues to step 522.

According to some examples, in step 522, the method includes receiving feedback from the user for the training data. Further, in step 522 user feedback 114 based on user interactions with UI 112 are used to generate additional training data for reinforcement learning, and, in step 524, reinforcement learning is applied to the ML model(s), which are trained using the additional training data. Steps 518 and 522 can be performed, e.g., by UI 112 and reinforcement learning processor 116 122 to generate updated ML coefficients 118 as illustrated in FIG. 1A, FIG. 1B, and FIG. 1D. Further, these steps can be performed using the techniques and processes described with reference to UI 112 and reinforcement learning processor 116.

For example, step 522 can include receiving feedback from the user, and the feedback cam include indicia of a correctness of the gift recommendations. For example, the UI 112 illustrated in FIG. 1A may receive feedback from the user.

According to some examples, the method includes performing reinforcement learning based on user feedback at step 524. For example, the reinforcement learning processor 116 illustrated in FIG. 1A may perform reinforcement learning based on user feedback 114.

According to some examples, the method includes augmenting collected data with user feedback at step 526. As illustrated by the dashed lines in FIG. 1A and FIG. 1B, user feedback 114 can be provided to recommender model 106. User feedback 114 can be combined with social media data 104 and other data used by recommender model 106 to generate recommendations for gifts 110 to improve the recommendations.

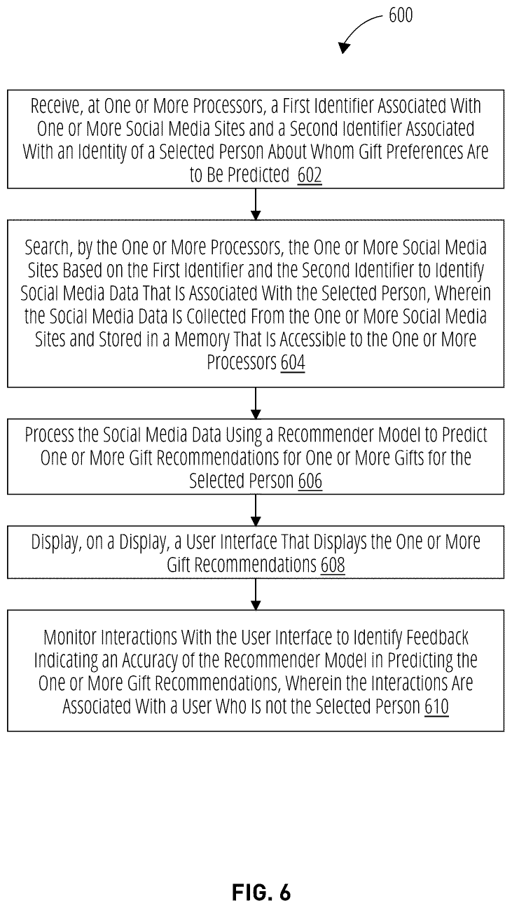

FIG. 6 illustrates an example routine 600 for generating gift recommendations based on social media data 104 of a prospective gift recipient. Although the example routine 600 depicts a particular sequence of operations, the sequence may be altered without departing from the scope of the present disclosure. For example, some of the operations depicted may be performed in parallel or in a different sequence that does not materially affect the function of the routine 600. In other examples, different components of an example device or system that implements the routine 600 may perform functions at substantially the same time or in a specific sequence.

According to some examples, the method includes receiving, at one or more processors, a first identifier associated with one or more social media sites and a second identifier associated with an identity of a selected person about whom gift preferences are to be predicted at block 602.

According to some examples, the method includes searching, by the one or more processors, the one or more social media sites based on the first identifier and the second identifier to identify social media data that is associated with the selected person, wherein the social media data is collected from the one or more social media sites and stored in a memory that is accessible to the one or more processors at block 604.

According to some examples, the method includes processing the social media data using a recommender model to predict gift recommendations for one or more gifts for the selected person at block 606.

According to some examples, the method includes displaying, on a display, a user interface that displays the gift recommendations at block 608.

According to some examples, the method includes monitoring interactions with the user interface to identify feedback indicating the accuracy of the recommender model in predicting the gift recommendations, wherein the interactions are associated with a user who is not the selected person at block 610.

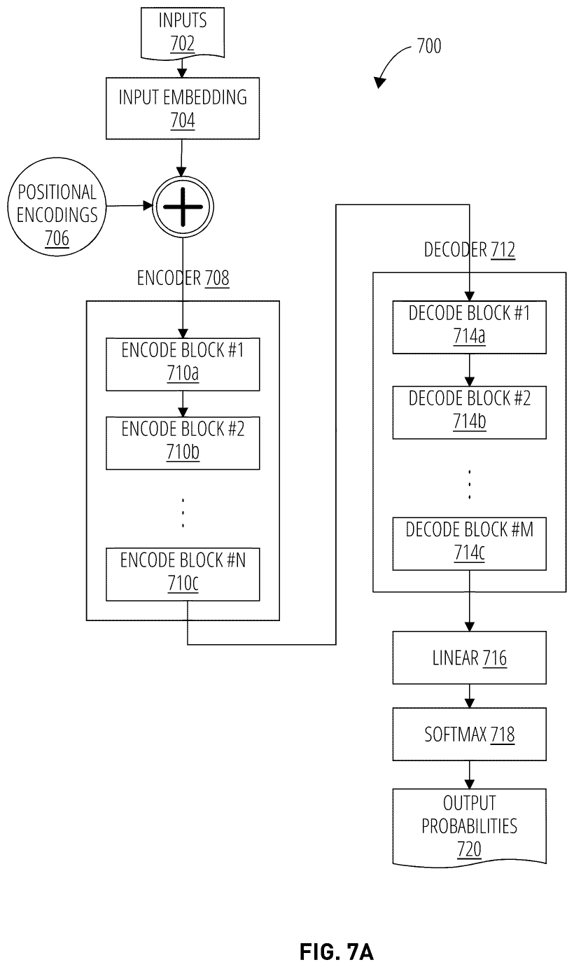

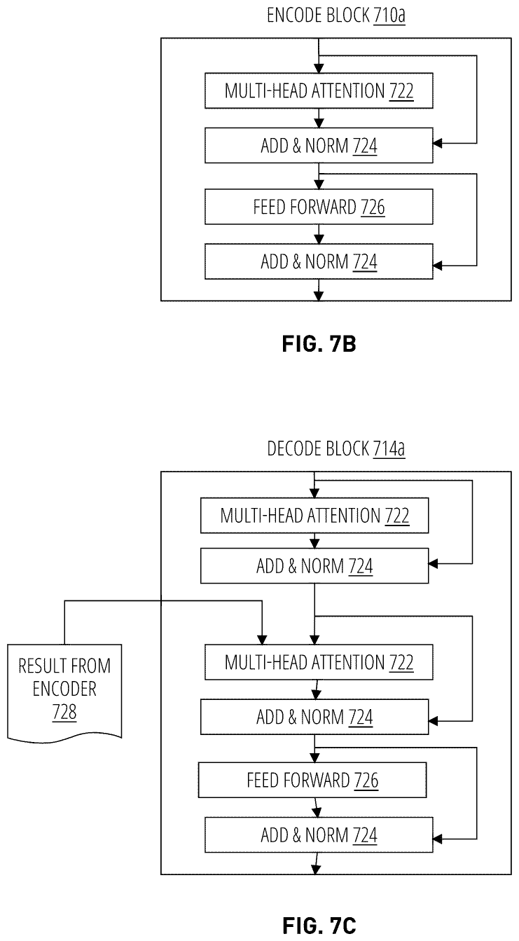

As discussed above, first model 120 and/or second model 124 can be an ML model, such as a transformer neural network. Examples of ML models that are transformer neural network include, e.g., generative pretrained transformer (GPT) models and Bidirectional Encoder Representations from Transformer (BERT) models. The transformer architecture 700, which is illustrated in FIG. 7A, FIG. 7B, and FIG. 7C, includes inputs 702, an input embedding block 704, positional encodings 706, an encoder 708 (e.g., encode block 710a, decode block 710b, and encode block 710c), a decoder 712 (e.g., decode block 714a, decode block 714b, and decode block 714c), a linear block 716, a softmax block 718, and an output probabilities 720.

The inputs 702 can include social media data 104 conveying information about a gift recipient. The transformer architecture 700 can be used as to take unstructured data and generate a structure profile of the gift recipient to determine the types of gifts the gift recipient is likely to want.

The input embedding block 704 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 704 can be learned embeddings to convert the input tokens and output tokens to vectors of dimension have the same dimension as the positional encodings, for example.

The positional encodings 706 provide information about the relative or absolute position of the tokens in the sequence. According to certain non-limiting examples, the positional encodings 706 can be provided by adding positional encodings to the input embeddings at the inputs to the encoder 708 and decoder 712. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that so doing allows the model to extrapolate to sequence lengths longer than the ones encountered during training.

The encoder 708 uses stacked self-attention and point-wise, fully connected layers. The encoder 708 can be a stack of N identical layers (e.g., N=6), and each layer is an encode block 710, as illustrated by encode block 710a shown in FIG. 7B. Each encode block 710 has two sub-layers: (i) a first sub-layer has a multi-head attention block 722 and (ii) a second sub-layer has a feed forward block 726, which can be a position-wise fully connected feed-forward network. The feed forward block 726 can use a rectified linear unit (ReLU).

The encoder 708 uses a residual connection around each of the two sub-layers, followed by an add & norm block 724, which performs normalization (e.g., the output of each sub-layer is LayerNorm(x+Sublayer(x)), i.e., the product of a layer normalization “LayerNorm” time the sum of the input “x” and output “Sublayer(x)” pf the sublayer LayerNorm(x+Sublayer(x)), where Sublayer(x) is the function implemented by the sub-layer). To facilitate these residual connections, all sub-layers in the model, as well as the embedding layers, produce output data having a same dimension.

Similar to the encoder 708, the decoder 712 uses stacked self-attention and point-wise, fully connected layers. The decoder 712 can also be a stack of M identical layers (e.g., M=6), and each layer is a decode block 414, as illustrated by encode decode block 714a shown in FIG. 7C. In addition to the two sub-layers (i.e., the sublayer with the multi-head attention block 722 and the sub-layer with the feed forward block 726) found in the encode block 710a, the decode block 714a can include a third sub-layer, which performs multi-head attention over the output of the encoder stack. Similar to the encoder 708, the decoder 712 uses residual connections around each of the sub-layers, followed by layer normalization. Additionally, the sub-layer with the multi-head attention block 722 can be modified in the decoder stack to prevent positions from attending to subsequent positions. This masking, combined with fact that the output embeddings are offset by one position, ensures that the predictions for position i can depend only on the known output data at positions less than i.

The linear block 716 can be a learned linear transformation. For example, when the transformer architecture 700 is being used to translate from a first language into a second language, the linear block 716 projects the output from the last decode block 714c into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

The softmax block 718 then turns the scores from the linear block 716 into output probabilities 720 (which add up to 1.0). In each position, the index provides for the word with the highest probability, and then map that index to the corresponding word in the vocabulary. Those words then form the output sequence of the transformer architecture 700. The softmax operation is applied to the output from the linear block 716 to convert the raw numbers into the output probabilities 720 (e.g., token probabilities).

Although the above example uses the case of translating from the first language to the second language to illustrate the functions of the transformer architecture 700, the output probabilities 720 can be other entities, such as probabilities of profile characteristics or probabilities that a gift recipient will like a particular gift. That is, the transformer architecture 700 can translate social media data 104 and other inputs to a profile of the prospective gift recipient or to probabilities that the gift recipient will appreciate receiving one or more items in gift database 108.

Generally, the transformer architecture 700 can generate output probabilities 720 related to the possible gifts to provide gift-giver with guidance regarding the best gifts for the gift recipient.

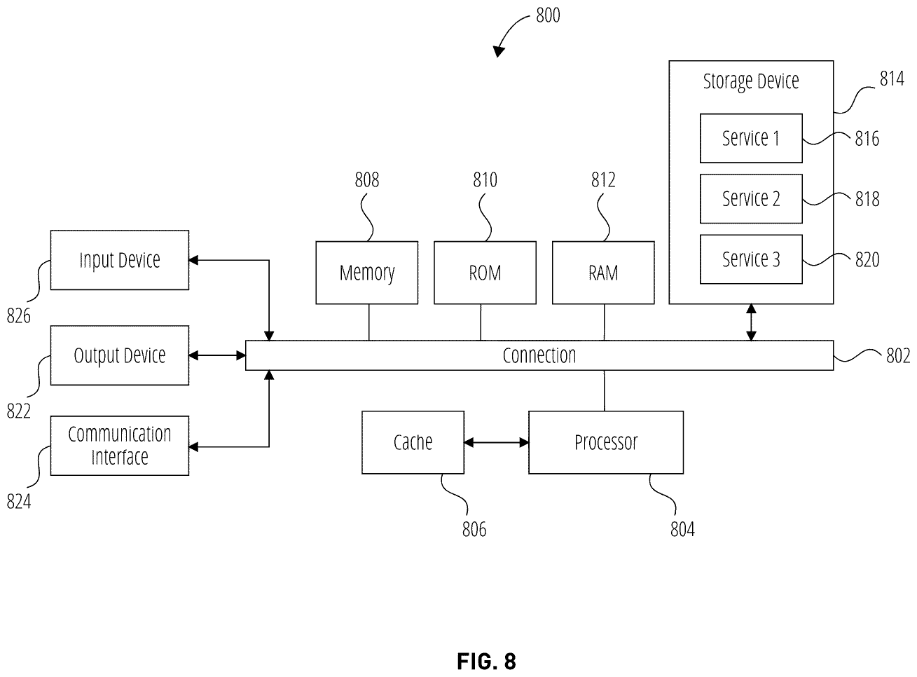

FIG. 8 shows an example of computing system 800. The computing system 800 can be system 102a, system 102b, system 102c, system 102d, or device 200. The computing system 800 can perform the functions of one or more of system 102a, system 102b, system 102c, system 102d, or device 200. The computing system 800 can be part of a distributed computing network in which several computers perform respective steps in method 300, GAN architecture 400, method 500, transformer architecture 700 and/or the functions of system 102a, system 102b, system 102c, system 102d, or device 200. The computing system 800 can be connected to the other parts of the distributed computing network via connection 802 or communication interface 824. Connection 802 can be a physical connection via a bus, or a direct connection into processor 804, such as in a chipset architecture. Connection 802 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 800 includes at least one processing unit (CPU or processor) 804 and connection 802 that couples various system components including system memory 808, such as read-only memory (ROM) 810 and random access memory (RAM) 812 to processor 804. Computing system 800 can include a cache of high-speed memory 806 connected directly with, in close proximity to, or integrated as part of processor 804. Processor 804 may essentially be a completely self-contained computing system, containing multiple cores or processors, a bus, memory controller, cache, etc. A multi-core processor may be symmetric or asymmetric.

Processor 804 can include any general-purpose processor and a hardware service or software service, such as services 816, 818, and 820 stored in storage device 814, configured to control processor 804 as well as a special-purpose processor where software instructions are incorporated into the actual processor design.

To enable user interaction, computing system 800 includes an input device 826, which can represent any number of input mechanisms, such as a microphone for speech, a touch-sensitive screen for gesture or graphical input, keyboard, mouse, motion input, speech, etc. Computing system 800 can also include output device 822, which can be one or more of a number of output mechanisms known to those of skill in the art. In some instances, multimodal systems can enable a user to provide multiple types of input/output to communicate with computing system 800. Computing system 800 can include a communication interface 824, which can generally govern and manage the user input and system output. There is no restriction on operating on any particular hardware arrangement, and therefore the basic features here may easily be substituted for improved hardware or firmware arrangements as they are developed.

Storage device 814 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 814 can include software services, servers, services, etc., that when the code that defines such software is executed by the processor 804, it causes the system to perform a function. In some embodiments, a hardware service that performs a particular function can include the software component stored in a computer-readable medium in connection with the necessary hardware components, such processor 804, connection 802, output device 822, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of system 102a, system 102b, system 102c, system 102d, or device 200 and performs one or more functions of method 300, GAN architecture 400, method 500, and/or transformer architecture 700 when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data that cause or otherwise configure a general-purpose computer, special-purpose computer, or special-purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, For example, instructions and data which cause or otherwise configure a general purpose computer, special purpose computer, or special purpose processing device to perform a certain function or group of functions. Portions of computer resources used can be accessible over a network. The computer executable instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for predicting gift preferences, the method comprising:
receiving, at one or more processors, a first identifier associated with one or more social media sites and a second identifier associated with an identity of a selected person about whom gift preferences are to be predicted;
searching, by the one or more processors, the one or more social media sites based on the first identifier and the second identifier to identify social media data that is associated with the selected person, wherein the social media data is collected from the one or more social media sites and stored in a memory that is accessible to the one or more processors;
processing the social media data using a recommender model to predict one or more gift recommendations for one or more gifts for the selected person;
displaying, on a display, a user interface that displays the one or more gift recommendations; and
monitoring interactions with the user interface to identify feedback indicating an accuracy of the recommender model in predicting the one or more gift recommendations, wherein the interactions are associated with a user who is not the selected person.

2. The method of claim 1, further comprising:
performing reinforcement learning using the feedback as training data to modify the recommender model.

3. The method of claim 2, wherein monitoring the interactions with the user interface to identify the feedback includes:
detecting that the interactions with the user interface indicate that a first gift recommendation of the one or more gift recommendations is a false positive,
adding, to the training data, an indicator of the first gift recommendation being the false positive,
detecting that the interactions with the user interface indicate that a second gift recommendation of the one or more gift recommendations is a true positive, and
adding, to the training data, an indicator of the second gift recommendation being the true positive.

4. The method of claim 1, wherein the recommender model includes a profile-generation model and a gift-prediction model, and processing the social media data using the recommender model to predict the one or more gift recommendations for the one or more gifts for the selected person includes:
processing the social media data using the profile-generation model to generate a profile of the selected person, and
processing the profile using the gift-prediction model to generate the one or more gift recommendations.

5. The method of claim 4, wherein processing the profile using the gift-prediction model to generate the one or more gift recommendations includes:
receiving contextual information that represents a context in which a gift is to be given to the selected person, and
processing the profile and the contextual information using the gift-prediction model to generate the one or more gift recommendations.

6. The method of claim 4, wherein the profile-generation model includes:
a text-analysis machine learning (ML) model that extracts first semantic content from text-based information in the social media data, wherein the text-analysis ML model includes at least one of a natural language processing (NLP) model, a named entity recognition model, a latent Dirichlet allocation model, a pre-trained language model, a transformer model, a Naive Bayes classifier model, a latent semantic analysis model, a singular value decomposition model, or a statistical model, and
an image-analysis ML model that extracts second semantic content from image-based information in the social media data, wherein the image-analysis model includes at least one of a semantic segmentation model, convolutional neural network model, an object detection model, a region-based model, a single shot detector model, a detection transformer model, or a vision transformer model, and
wherein the profile-generation model generates the profile of the selected person based on the first semantic content and the second semantic content.

7. The method of claim 4, wherein the gift-prediction model includes a prediction machine learning (ML) model that predicts gift preferences using the profile, wherein the prediction ML model includes a random forest model, a support vector machine model, a deep learning model, a recursive neural network model, a transformer model, a K-nearest neighbor-based collaborative filter model, a clustering model, or a classifier model.

8. The method of claim 1, wherein the recommender model includes a profile-generation model, a prediction model, and a prediction-narrowing model, wherein processing the social media data using the recommender model to predict the one or more gift recommendations for the one or more gifts for the selected person includes:
processing the social media data using the profile-generation model to generate a profile of the selected person,
processing the profile using the prediction model to generate a gift preference of the selected person, and
processing the gift preference and shopping information associated with the selected person using the prediction-narrowing model to generate the one or more gift recommendations for the selected person, wherein the shopping information includes at least one of a purchase history, a wish list, or one or more product reviews.

9. The method of claim 1, wherein receiving the second identifier associated with the identity of the selected person includes at least one of:
receiving, via the user interface, a user input indicating the identity of the selected person, or
receiving, from an application, event data indicative of an event associated with the selected person, wherein the identity of the selected person is ascertainable from the event data.

10. The method of claim 1, further comprising:
receiving, via the user interface, a selection of a data privacy option of a plurality of data privacy options; and
excluding a subset of the social media data based on the data privacy option before processing the social media data using the recommender model to predict the one or more gift recommendations for one or more gifts for the selected person.

11. A system comprising:
one or more processors comprising a recommender model;
a display configured to display a user interface; and
a memory storing instructions that, when executed by the one or more processors, configure the system to:
receive a first identifier associated with one or more social media sites and a second identifier associated with an identity of a selected person about whom gift preferences are to be predicted;
search the one or more social media sites based on the first identifier and the second identifier to identify social media data that is associated with the selected person, wherein the social media data is collected from the one or more social media sites and stored in the memory;
process the social media data to the recommender model to predict one or more gift recommendations based, at least in part, on the social media data;
display, on the display, the user interface that displays the one or more gift recommendations; and
monitor interactions with the user interface to identify feedback indicating an accuracy of the recommender model in predicting the one or more gift recommendations, wherein the interactions are associated with a user who is not the selected person.

12. The system of claim 11, wherein the instructions further configure the system to:
perform reinforcement learning using the feedback as training data to modify the recommender model to improve the accuracy.

13. The system of claim 12, wherein the instructions further configure the system to monitor the interactions with the user interface to identify the feedback by configuring the system to:
detect that the interactions with the user interface indicate that a first gift recommendation of the one or more gift recommendations is a false positive,
add, to reinforcement training data, an indicator of the first gift recommendation being the false positive,
detect that the interactions with the user interface indicate that a second gift recommendation of the one or more gift recommendations is a true positive,
add, to the reinforcement training data, an indicator of the second gift recommendation being the true positive, and
perform reinforcement learning using the reinforcement training data to modify the recommender model.

14. The system of claim 11, wherein:
the recommender model includes a profile-generation model and a gift-prediction model, and
the instructions further configure the system to process the social media data using the recommender model to predict the one or more gift recommendations by configuring the system to:
process the social media data using the profile-generation model to generate a profile of the selected person, and
process the profile using the gift-prediction model to generate the one or more gift recommendations.

15. The system of claim 14, wherein the instructions further configure the system to apply the profile to the gift-prediction model to generate one or more of the gift recommendations by configuring the system to:
receive contextual information that represents a context in which a gift would be given to the selected person, and
apply the profile together with the contextual information to the gift-prediction model to generate one or more of the gift recommendations.

16. The system of claim 14, wherein the profile-generation model includes:
a text-analysis machine learning (ML) model that extracts first semantic content from text-based information in the social media data, wherein the text-analysis ML model includes at least one of a natural language processing (NLP) model, a named entity recognition model, a latent Dirichlet allocation model, a pre-trained language model, a transformer model, a Naive Bayes classifier model, a latent semantic analysis model, a singular value decomposition model, or a statistical model, and
an image-analysis ML model that extracts second semantic content from image-based information in the social media data, wherein the image-analysis model includes at least one of a semantic segmentation model, a convolutional neural network model, an object detection model, a region-based model, a single shot detector model, a detection transformer model, or a vision transformer model, wherein
the profile-generation model generates the profile of the selected person based on the first semantic content and the second semantic content.

17. The system of claim 14, wherein the gift-prediction model includes a prediction machine learning (ML) model that predicts gift preferences using the profile, wherein the prediction ML model includes a random forest model, a support vector machine model, a deep learning model, a recursive neural network model, a transformer model, a K-nearest neighbor-based collaborative filter model, a clustering model, or a classifier model.

18. The system of claim 11, wherein:
the recommender model includes a profile-generation model, a prediction model, and a prediction-narrowing model, and
the instructions further configure the system to process the social media data using the recommender model to predict the one or more gift recommendations by configuring the system to:
process the social media data using the profile-generation model to generate a profile of the selected person,
process the profile using the prediction model to generate a gift preference of the selected person, and
process the gift preference and shopping information associated with the selected person using the prediction-narrowing model to generate the one or more gift recommendations for the selected person, wherein the shopping information includes at least one of a purchase history, a wish list, or one or more product reviews.

19. The system of claim 11, wherein the instructions further configure the system to receive the second identifier associated with the identity of the selected person by configuring the system to:
receive, via the user interface, a user input indicating the identity of the selected person, or
receive, from an application, event data indicative of an event associated with the selected person, wherein the identity of the selected person is ascertainable from the event data.

20. A non-transitory computer-readable storage medium, the computer-readable storage medium including instructions that when executed by a computer, cause the computer to:
receive a first identifier associated with one or more social media sites and a second identifier associated with an identity of a selected person about whom gift preferences are to be predicted;
search the one or more social media sites based on the first identifier and the second identifier to identify social media data that is associated with the selected person, wherein the social media data is collected from the one or more social media sites and stored in a memory that is accessible to the computer;
process the social media data using a recommender model to predict one or more gift recommendations based, at least in part, on the social media data;
display, on the display, a user interface that displays the one or more gift recommendations; and
monitor interactions with a user interface to identify feedback indicating an accuracy of the recommender model in predicting the one or more gift recommendations, wherein the interactions are associated with a user who is not the selected person.
